(19) United States
(12) Patent Application Publication
(10) Pub. No.: US 2021/0278832 A1
(43) Pub. Date: Sep. 9, 2021

(54) MAINTENANCE PLAN FORMULATION DEVICE, METHOD, AND NON-TRANSITORY MEDIUM

(71) Applicant: NEC CORPORATION, Tokyo (JP)

(72) Inventors: Shigeru KOUMOTO, Tokyo (JP); Rie IWASAKI, Tokyo (JP); Eisuke SANEYOSHI, Tokyo (JP); Akira SHOUJIGUCHI, Tokyo (JP); Takahiro TOIZUMI, Tokyo (JP); Ryota SUZUKI, Tokyo (JP)

(73) Assignee: NEC CORPORATION, Tokyo (JP)

(21) Appl. No.: 16/314,239

(22) PCT Filed: Jun. 28, 2017
(86) PCT No.: PCT/JP2017/023805

§ 371 Date: Dec. 28, 2018

(30) Foreign Application Priority Data
Jun. 30, 2016 (JP) 2016-130767

(51) Int. Cl. G05B 23/02; G05B 19/418

(52) U.S. Cl. CPC G05B 23/0283; G05B 23/0218; G05B 19/41885; G05B 19/4184; G05B 19/4183

(57) ABSTRACT

A maintenance plan formulation device includes: a failure sign detection unit that acquires a state of at least an apparatus and detects an abnormality indicating a sign that appears before a failure of the apparatus occurs; a maintenance limit timing calculation unit that calculates a maintenance limit timing that indicates a limit of a maintenance timing of the apparatus with the abnormality thereof being detected; a maintenance timing calculation unit that calculates a maintenance timing of the apparatus based on the maintenance limit timing of the apparatus; and a maintenance timing output part that outputs the maintenance timing to a display apparatus.

### REFERENCE TO RELATED APPLICATION

This Application is a National Stage of International Application No. PCT/JP2017/023805 filed Jun. 28, 2017, claiming priority based on Japanese Patent Application No. 2016-130767, filed on Jun. 30, 2016, the disclosure of which is incorporated herein in its entirety by reference thereto.

### FIELD

The present invention relates to a device, a method, and a non-transitory medium suitable for formulation of maintenance plans for equipment, etc.

### BACKGROUND

There is known a method for maintaining and managing an apparatus such as an equipment and an appliance installed at factory, store, or the like. In this method, for example, a sign that appears before a failure of an apparatus occurs is detected by acquiring a power supply current, vibration, or the like of the apparatus using a current sensor, a vibration sensor, or the like and analyzing the acquired information in accordance with various methods. If a sign of a failure is detected, a minor abnormality can be detected at an early stage, and an as-needed maintenance operation (a maintenance operation performed only as needed) can be performed. Thus, less maintenance cost is needed as compared with that needed by a regular maintenance operation or the like. In addition, by performing a maintenance operation based on a sign of a failure that has been detected, a failure can be avoided, and the life of the corresponding apparatus can be extended.

For example, PTL 1 discloses an elevator diagnosis apparatus including: a current meter which is attached to a power line of an elevator control panel and which measures a current; a vibration sensor which is removably attached to a place near a control relay of the elevator control panel and which measures a vibration waveform that occurs with switching of the control relay; a waveform detector which detects signals measured by the current meter and the vibration sensor as a measured current waveform and a measured vibration waveform, respectively; a comparator which reads a normal current waveform and a normal vibration waveform stored in storage means and which compares these normal current and vibration waveforms with the measured current and vibration waveforms; determination means which determines whether there is a failure or a sign of a failure based on the results of the comparisons of the current and vibration waveforms; and output means which outputs a determination result.

In addition, for example, PTL 2 discloses a technique for improving efficiency of work management of regular inspections on machine tool equipment or the like at factories, etc. Specifically, PTL 2 discloses an apparatus configuration including: a production management unit equipped with function of managing production plans and production results; an equipment management unit equipped with function of managing operating results of the individual equipment, lead times of the individual work processes, and regular inspection plans, regular inspection results, and adjustment work results about an equipment(s) in individual work processes; an equipment operation state model management unit that manages equipment operation state models within control means for controlling the equipment in the individual work processes; an equipment operation state model record management unit that manages records of equipment operation state models prior to occurrence of malfunctions of the equipment in the equipment operation state models, contents of errors corresponding to the equipment operation state models, and contents of adjustment work; a workforce management unit that manages the number of workers and information about the individual workers; a scheduling unit that performs scheduling about timing of work input, discharge, regular inspection, and adjustment work in the individual work processes, allocation of work to the workers, etc.; and a control unit that controls the individual parts.

In addition, PTL 3 discloses a method for giving a solution to joint scheduling of asset maintenance and necessary plant production in response to a maintenance trigger and a production order. A new maintenance trigger is acquired, and a maintenance request proposing new maintenance scheduling is converted into production scheduling. In a production scheduling (PS) system, a maintenance request is converted into production scheduling. Alternatively, regarding a computerized maintenance management system (CMMS), there is disclosed an arrangement for ensuring a maintenance action time slot.

In addition, regarding acquisition of a power supply current waveform of equipment and appliance (apparatus), there is discussed an arrangement in which a controller acquires a current waveform, a voltage waveform, etc. in real time from measuring instrument installed at electrical equipment (apparatus) in a home energy management system (HEMS), a building energy management system (BEMS), a factory energy management system (FEMS), or the like. There is also discussed use of appliance disaggregation technology. In this technology, a waveform of current flowing through a main switch or the like of a power distribution board is observed, and the observed current waveform is forwarded to a cloud server via a communication network. Next, the waveform is disaggregated into waveforms of individual appliances by using machine learning, artificial intelligence, or the like on the cloud server, to estimate power consumption and on/off of each appliance (NPL 1).

In addition, as a related technique for determining a state of an electrical appliance based on a power waveform, for example, NPL 2 discloses a method including: acquiring a waveform of a current (an instantaneous waveform in one period) flowing through a main power line by using a single current sensor attached on a power distribution board, analyzing the waveform by referring to a waveform database including information about current waveforms (also referred to as “electricity fingerprints”) unique to individual appliances, estimating the power consumption of each appliance, and determining the states of the appliances.

### CITATION LIST

### Patent Literature

PTL 1: Registered Utility Model No. 3166788

PTL 2: Japanese Patent Kokai Publication No. JP-H11-129147A

PTL 3: U.S. Patent Application Publication No. 2003/0130755

### Non Patent Literature

NPL 1: “Joint demonstration with Tokyo Electric Power Company Holdings on service using appliance disaggregation technology”, Informetis Co., Ltd. [searched on May 1, 2016] Internet (URL:http://prtimes.jp/main/html/rd/p/000000001.000012366.html)

NPL 2: Shigeru Koumoto, Takahiro Toizumi, Eisuke Saneyoshi, “Electricity Fingerprint Analysis Technology for Monitoring Power Consumption and Usage Situations of Multiple Appliances by Using One Sensor”, NEC Technical Journal/Vol.68 No.2/Special Issue on NEC's Smart Energy Solutions Led by ICT

### SUMMARY

The following describes analysis of the related technologies.

In a case where when a sign of a failure is detected in one of a plurality of apparatuses that form a production line or the like at a factory, an as-needed maintenance operation is performed on the apparatus, the operation of this production line is stopped. Thus, the production plan or the like is changed.

That is, it is impossible to determine a maintenance plan that can suppress reduction of operation efficiency, productivity, or the like of a production line at a factory or the like, while adopting as-needed maintenance operation. This is where things are currently. Likewise, it is impossible to determine a maintenance plan that avoids, for example, reduction of sales at a store while adopting as-needed maintenance operation.

The present invention has been made in view of the above issues, and it is an object of the present invention is to provide a method, an apparatus, and a non-transitory medium storing a program, each enabling to formulate a maintenance plan that can suppress reduction of operation efficiency, productivity, or the like of a production line or the like while adopting a maintenance operation performed based on a sign of a failure of an apparatus. Other problems and objects than those described above will become apparent from the present description and the accompanying drawings.

According to one aspect of the present invention, there is provided a maintenance plan formulation device including: a failure sign detection unit that acquires a state of at least an apparatus and detects an abnormality indicating a sign that appears before a failure of the apparatus occurs; a maintenance limit timing calculation unit that calculates a maintenance limit timing that indicates a limit of a maintenance timing of the apparatus with the abnormality thereof being detected; a maintenance timing calculation unit that calculates a maintenance timing of the apparatus based on the maintenance limit timing of the apparatus; and a maintenance timing output unit that outputs the maintenance timing to a display apparatus.

According to another aspect of the present invention, there is provided a maintenance plan formulation method performed by a computer, the method including: a failure sign detection step for acquiring a state of at least an apparatus and detects an abnormality indicating a sign that appears before a failure of the apparatus occurs; a maintenance limit timing calculation step for calculating a maintenance limit timing that indicates a limit of a maintenance timing of the apparatus with the abnormality thereof being detected; a maintenance timing calculation step for calculating a maintenance timing of the apparatus based on the maintenance limit timing of the apparatus; and a step for outputting the maintenance timing to a display apparatus.

According to still another aspect of the present invention, there is provided a program causing a computer to perform:

failure sign detection processing for acquiring a state of an apparatus to detect an abnormality indicating a sign that appears before a failure of the apparatus occurs;

maintenance limit timing calculation processing for calculating a maintenance limit timing that indicates a limit of a maintenance timing of the apparatus with the abnormality thereof being detected;

maintenance timing calculation processing for calculating a maintenance timing of the apparatus based on the maintenance limit timing of the apparatus; and

processing for outputting the maintenance timing to a display apparatus.

According to the present invention, there is provided a computer-readable recording medium holding the above program (for example, a non-transitory computer-readable recording medium such as a semiconductor storage such as a random access memory (RAM), a read-only memory (ROM), or an electrically erasable and programmable ROM (EEPROM), a hard disk drive (HDD), a compact disc (CD), or a digital versatile disc (DVD)).

According to the present invention, it is possible to formulate a maintenance plan that can suppress reduction of the operation efficiency, the productivity, or the like of a production line or the like while adopting a maintenance operation performed based on a sign of a failure of an apparatus. Other advantageous effects than those described above will become apparent from the present description and the accompanying drawings.

### BRIEF DESCRIPTION OF DRAWINGS

FIG. 1 illustrates an example of an arrangement according to a first example embodiment of the present invention.

FIG. 2 is a flowchart illustrating an example of an operation according to the first example embodiment of the present invention.

FIG. 3 illustrates an example of an arrangement of a failure sign detection unit according to the first example embodiment of the present invention.

FIG. 4 is a flowchart illustrating an example of an operation of the failure sign detection unit according to the first example embodiment of the present invention.

FIG. 5 illustrates an example of an arrangement of a maintenance limit timing calculation unit according to the first example embodiment of the present invention.

FIG. 6 is a flowchart illustrating an example of an operation of the maintenance limit timing calculation unit according to the first example embodiment of the present invention.

FIG. 7A is a diagram illustrating the maintenance limit timing calculation unit according to the first example embodiment of the present invention.

FIG. 7B is a diagram illustrating the maintenance limit timing calculation unit according to the first example embodiment of the present invention.

FIG. 8 illustrates an example of an arrangement of a maintenance timing calculation unit according to the first example embodiment of the present invention.

FIG. 9 is a flowchart illustrating an example of an operation of the maintenance timing calculation unit according to the first example embodiment of the present invention.

FIG. 10 illustrates an example according to the first example embodiment of the present invention.

FIGS. 11 is a diagram where (A) to (C) illustrate a comparative example.

FIGS. 12 is a diagram where (A) to (C) illustrate an application example (the first example embodiment) of the present invention.

FIGS. 13 is a diagram a diagram where (A) and (B) illustrate the first example embodiment of the present invention.

FIG. 14 illustrates a second example embodiment of the present invention.

FIG. 15 illustrates variation 1 ofthe second example embodiment of the present invention.

FIG. 16 illustrates variation 2 of the second example embodiment of the present invention.

FIGS. 17 is a diagram where (A) to (C) illustrate the second example embodiment of the present invention.

FIG. 18A illustrates an example embodiment of the present invention.

FIG. 18B illustrates an example embodiment of the present invention.

FIG. 19A illustrates an example embodiment of the present invention.

FIG. 19B illustrates an example embodiment of the present invention.

FIG. 20 illustrates an example embodiment of the present invention.

FIG. 21 is a diagram where (A) to (C) illustrate an example embodiment of the present invention.

### DETAILED DESCRIPTION

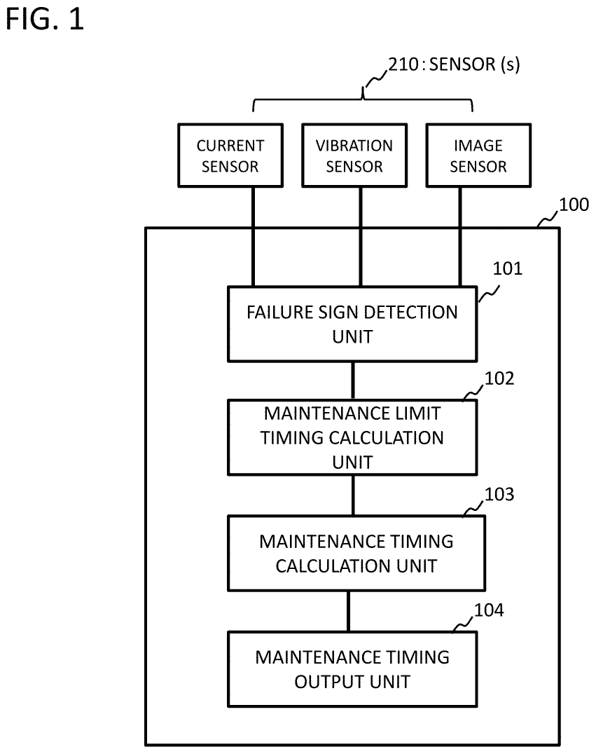

Example embodiments of the present invention will hereinafter be described with reference to drawings. An example embodiment of the present invention may include:
a failure sign detection unit (101 in FIG. 1) (failure sign detection means/step/processing) which acquires a state of at least an apparatus and detects an abnormality indicating a sign that appears before a failure of the apparatus occurs;
a maintenance limit timing calculation unit (102 in FIG. 1) (maintenance limit timing calculation means/step/processing) which calculates a maintenance limit timing that indicates a limit of a maintenance timing of the apparatus in which the abnormality has been detected;
a maintenance timing calculation unit (103 in FIG. 1) (maintenance timing calculation means/step/processing) which calculates a maintenance timing of the apparatus based on the maintenance limit timing of the apparatus; and
a maintenance timing output part (104 in FIG. 1) (maintenance timing output means/step/processing) which outputs the maintenance timing to a display apparatus.

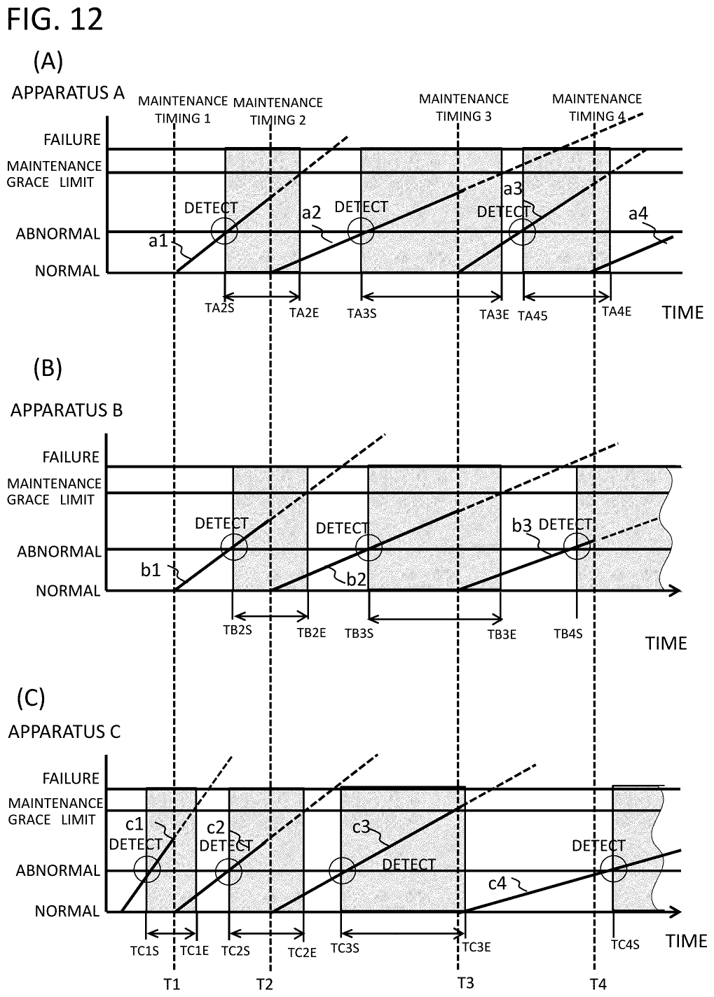

According to the example embodiment of the present invention, the maintenance limit timing calculation unit (FIG. 1 in 102) may generate the maintenance grace period(s) (for example, FIG. 12) of the apparatus(es), each grace period having a starting point set to a time when a corresponding abnormality is detected in the corresponding apparatus by the failure sign detection unit and an end point set to the corresponding maintenance limit timing. The maintenance timing calculation unit (103 in FIG. 1) may set the maintenance timing of the apparatus(es) to a preset time within the maintenance grace period.

According to the example embodiment of the present invention, based on the maintenance grace period calculated for one apparatus and the maintenance grace period calculated for at least one other apparatus, the maintenance timing calculation unit (103 in FIG. 1) may calculate a maintenance timing of the one apparatus and a maintenance timing of the at least one other apparatus. According to the example embodiment of the present invention, based on the maintenance grace period calculated for the apparatus and the maintenance grace period calculated for at least one other apparatus, the maintenance timing calculation unit (103 in FIG. 1) may calculate a maintenance timing common to the apparatus and the at least one other apparatus.

According to the example embodiment of the present invention, based on a maintenance grace period (for example, a time period [TA2S, TA2E] in (A) of FIG. 12) calculated for a certain apparatus (for example, an apparatus A in (A) of FIG. 12) and a maintenance grace period(s) (for example, a time period [TB2S, TB2E] and/or a time period [TC2S, TC2E] in (B) and (C) in FIG. 12) calculated for at least one other apparatus (for example, an apparatus B and/or an apparatus C), the maintenance timing calculation unit (103 in FIG. 1) may calculate a maintenance timing common to the apparatus A and the at least one other apparatus (the apparatus B and/or the apparatus C). Specifically, the maintenance timing calculation unit (103 in FIG. 1) sets, as the common maintenance timing, a maintenance timing common to these apparatuses in a time period when the maintenance grace periods of these apparatuses temporally overlap. As a result, maintenance operations can be performed on the plurality of apparatuses in a single common maintenance timing.

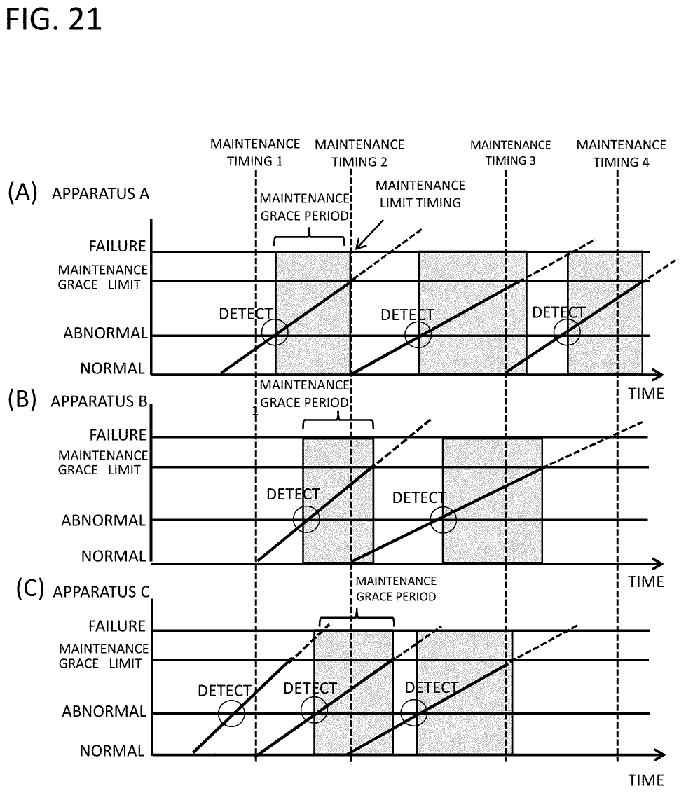

For example, in the example in FIG. 12, which will be described in detail in the following example embodiment, by setting a maintenance timing in a time (period) T2 when maintenance grace periods of the apparatuses A to C overlap, maintenance operations on the apparatuses A to C can be performed at once. In this case, when failure sign detection results corresponding to the apparatuses A to C forming a production line are obtained, for example, maintenance operations can be performed on the apparatuses A to C by stopping the line only once. In addition, according to the example embodiment of the present invention, the maintenance timing calculation unit may determine a maintenance timing based on maintenance grace periods calculated for apparatuses B and C ((B) and (C) in FIG. 21) and a maintenance grace period end date (period) calculated for an apparatus A ((A) of FIG. 21). In this case, the maintenance timing calculation unit can delay a maintenance timing as long as possible.

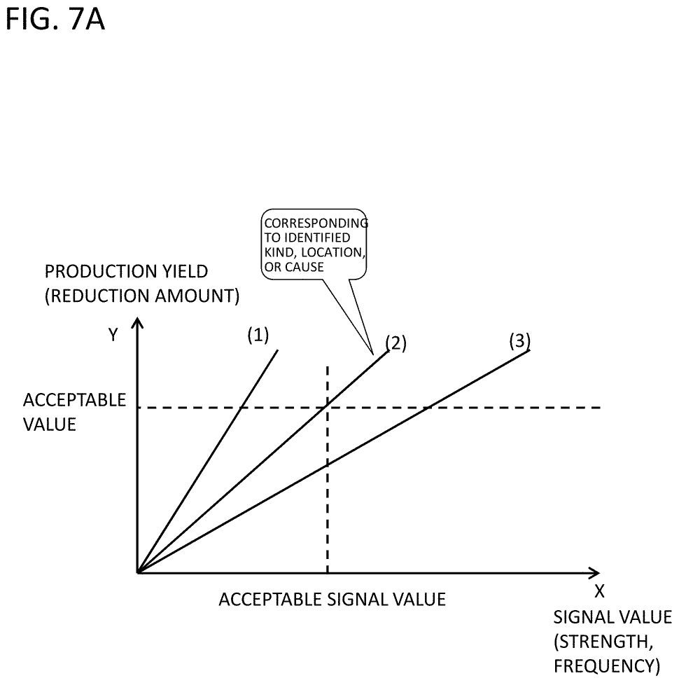

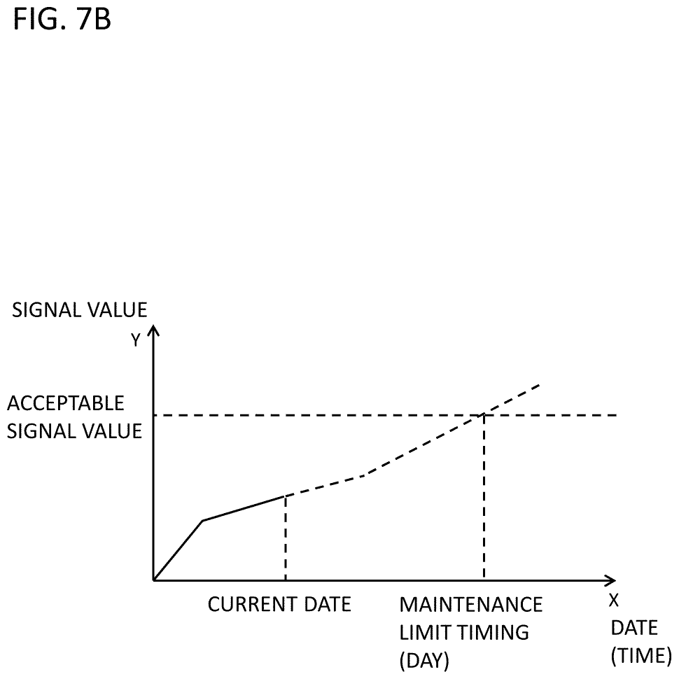

According to the example embodiment of the present invention, the maintenance limit timing calculation unit (102 in FIG. 1) may calculate the maintenance limit timing based on a temporal transition of the state of the apparatus after the abnormality is detected and an acceptable value of the state of the apparatus (for example, “acceptable signal value” in FIG. 7B or “maintenance grace limit” in (A) to (C) of FIG. 12 described in detail in the following example embodiment).

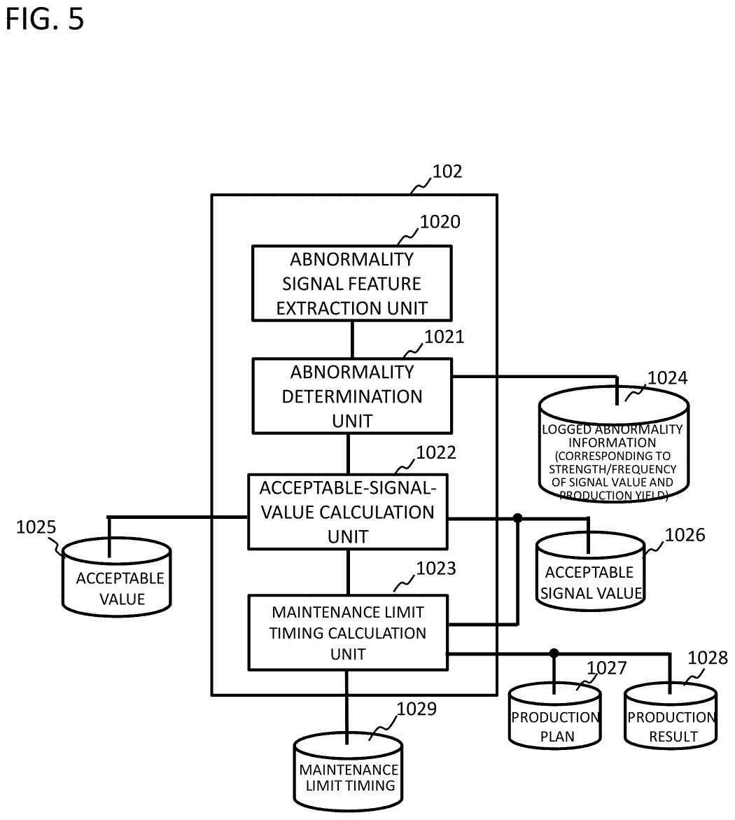

According to the example embodiment of the present invention, based on logged (previous) h abnormality information (for example, 1024 in FIG. 5) corresponding to the detected abnormality of the apparatus, the maintenance limit timing calculation unit (102 in FIG. 1) may calculate an acceptable value of a signal value representing a degree of deterioration of the state of the apparatus (for example, “acceptable signal value” in FIGS. 7A and 7B) in association with an acceptable value(s) about a yield or the like of a product produced by the apparatus(es) (for example, “acceptable value” about the production yield (reduction amount) in FIG. 7A which will be described in detail in the following example embodiment. According to the example embodiment of the present invention, the logged abnormality information may include a correlation between yield (a reduction amount) of a product produced by the apparatus and a signal value representing deterioration of the state of the apparatus (for example, graphs (1) to (3) in FIG. 7A). In FIG. 7A, the acceptable value regarding yield (reduction amount) of a product may be an acceptable value regarding a failure rate of the product. Alternatively, the acceptable value may be an acceptable variation (fluctuation) range or the like in product quality or the like.

According to the example embodiment of the present invention, based on at least one of a kind, a location, and a cause of the detected abnormality of an individual one of the apparatuses, the maintenance limit timing calculation unit (102 in FIG. 1) may select logged abnormality information (for example, one of graphs (1) to (3) in FIG. 7A) that corresponds to the at least one of a kind, a location, and a cause of the abnormality, calculate an acceptable signal value (for example, “acceptable signal value” in FIG. 7B) corresponding to the acceptable value of a yield of the product produced by the apparatus with regard to the selected abnormality information, and determine the acceptable signal value as the acceptable value regarding the state of the apparatus.

According to the example embodiment of the present invention, the maintenance limit timing calculation unit (102 in FIG. 1) may calculate a maintenance limit timing (for example, “maintenance limit timing (date)” in FIG. 7B) based on prediction of a temporal transition after the abnormality of the state of the apparatus is detected, the prediction being predicted based on production plan information (for example, 1027 in FIG. 5) regarding the product produced by the apparatus in which the abnormality has been detected and production result information (for example, 1028 in FIG. 5) and the acceptable value regarding the state of the apparatus (for example, “acceptable signal value” in FIG. 7B).

According to the example embodiment of the present invention, the maintenance limit timing calculation unit (102 in FIG. 1) may calculate the maintenance limit timing (for example, “maintenance limit timing (date)” in FIG. 7B) based on prediction of a temporal transition after the abnormality of the state of the apparatus is detected, the prediction being made based on information about a sales target and a sales result of a product relating to the apparatus in which the abnormality has been detected and the acceptable value regarding the state of the apparatus.

According to the example embodiment of the present invention, the maintenance timing calculation unit (103 in FIG. 1) may calculate the maintenance timing of the apparatus based on, in addition to the maintenance limit timing of the apparatus, information about at least one of the maintenance limit timing of at least one other apparatus, a non-operating period, and a production stage replacement period.

According to another example embodiment of the present invention, the maintenance timing calculation unit (103 in FIG. 1) may calculate the maintenance timing of the apparatus based on, in addition to the maintenance limit timing of the apparatus and a maintenance limit timing for at least a different abnormality detected in the apparatus, information about at least one of the maintenance limit timing of at least one other apparatus, a non-operating period, and a production stage replacement period.

According to the example embodiment of the present invention, the failure sign detection unit (101 in FIG. 1) may detect abnormality of the apparatus based on information acquired by at least one sensor which is one of a current sensor that acquires a power supply current of the apparatus, a vibration sensor that detects a vibration of the apparatus, and an image sensor that acquires image information on the apparatus.

According to the example embodiment of the present invention, the failure sign detection unit (101 in FIG. 1) may acquire a power supply current waveform of the apparatus and detect an abnormality by comparing a feature amount of the power supply current waveform with a preset threshold.

In addition, according to the example embodiment of the present invention, when the failure sign detection unit (101 in FIG. 1) detects an abnormality indicating a sign that appears before a failure and detects an abnormality by performing comparison with a predetermined threshold, the failure sign detection unit may use a method such as machine learning. For example, as the machine learning, at least one of the following may be used:
Support Vector Machine (SVM),
k-Nearest Neighbor Method (k-NN method),
k-Means Clustering Method (k-Means method),
Neural Network (NN),
Local Outlier Factor Method (LOF method), and so forth.

According to the example embodiment of the present invention, the failure sign detection unit may acquire a power supply current waveform of the apparatus and detect an abnormality about the state of the apparatus by comparing a feature amount of the power supply current waveform with a preset threshold, and the maintenance limit timing calculation unit may calculate the maintenance limit timing based on an acceptable value preset with regard to the feature amount of the power supply current waveform of the apparatus in which the abnormality has been detected and a future temporal transition of the feature amount of the power supply current waveform of the apparatus. The present invention enables appropriate formulation of a maintenance plan while adopting a maintenance operation performed based on detection of a sign indicating a failure of an apparatus. According to the present invention, the number of maintenance operations performed based on detection of a sign of a failure of each apparatus can be reduced. That is, the number of times of stoppage of a production line including the apparatus can be reduced, and the stoppage time or the like can be reduced. Thus, the present invention can contribute to improving operation efficiency and productivity.

### FIRST EXAMPLE EMBODIMENT

FIG. 1 illustrates an arrangement according to a first example embodiment of the present invention. As illustrated in FIG. 1, a maintenance plan formulation device 100 includes a failure sign detection unit 101 (failure sign detection means), a maintenance limit timing calculation unit 102 (maintenance limit timing calculation means), a maintenance timing calculation unit 103 (maintenance timing calculation means), and a maintenance timing output unit 104 (maintenance timing output means).

The failure sign detection unit 101 (failure sign detection means) acquires a current waveform, a vibration waveform, image information, etc. about each of one or more monitoring target apparatuses from various sensors 210 such as a current sensor, a vibration sensor, an image sensor, etc. and detects an abnormality indicating a sign of a failure of the apparatus. The maintenance limit timing calculation unit 102 (maintenance limit timing calculation means) calculates a maintenance limit timing of the apparatus in which the abnormality has been detected. Based on the calculated maintenance limit timings of a plurality of apparatuses, the maintenance timing calculation unit 103 (maintenance timing calculation means) calculates a maintenance timing, for example, in view of the number of maintenance operations, stoppage of a production line or the like. The maintenance timing output unit 104 (maintenance timing output means) outputs the calculated maintenance timing to a display apparatus or the like, for example.

In the embodiment, only a current sensor may be used as the sensor 210. Alternatively, a combination of a current sensor and a vibration sensor, a combination of a current sensor and an image sensor, or a combination of a current sensor, a vibration sensor, and an image sensor may be used.

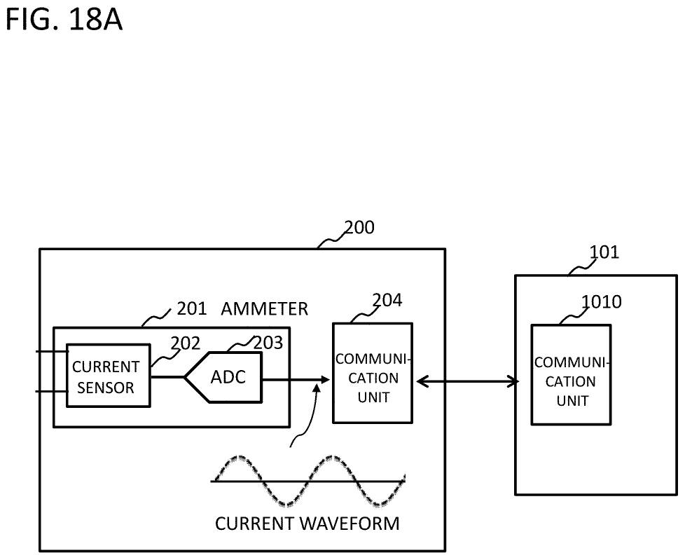

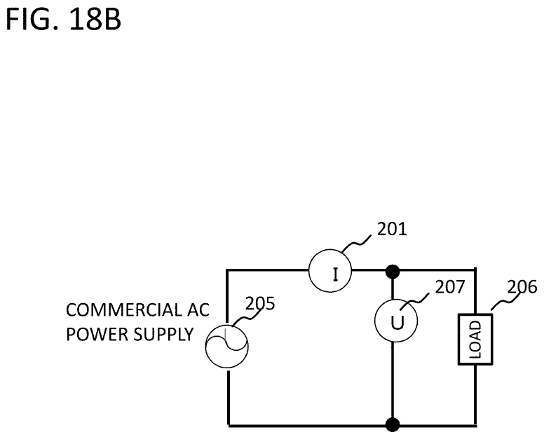

A current sensor acquires, for example, a waveform of a power supply current flowing through a power supply line of a commercial power supply of an apparatus. A plurality of current sensors that acquire waveforms of power supply currents of a plurality of production (machining) apparatuses or electrical equipment installed at a production line or the like at a factory may be used. For example, as illustrated in FIG. 18B, an ammeter 201 is inserted in a power supply line of a commercial AC power supply 205 and monitors a power supply current flowing through a load 206 (an apparatus). FIG. 18A illustrates an example of a measuring instrument 200 including the ammeter 201 in FIG. 18B. A current sensor 202 in the ammeter 201 may measure a voltage between terminals of a shunt resistor (not illustrated) inserted in the power supply line. Alternatively, the current sensor 202 may have an arrangement of a current transformer having a coil wound around a magnetic core or the like. For example, the current sensor 202 may be a current transformer (CT) sensor. In this case, a cable whose current is to be measured is enclosed by a core of a CT sensor, and the CT sensor detects a current converted from a detection value of the magnetic flux flowing through the magnetic core. An output value such as an output voltage from the current sensor 202 is converted into digital waveform data by an analog-to-digital (A/D) converter 203 and is transmitted from a communication unit 204. While FIG. 18B illustrates an arrangement of an AC in a single-phase two-wire system, for example, currents can be measured by using three ammeters or the like in the case of an AC in a three-phase three-wire system. The measuring instrument 200 may include a voltmeter that acquires a power supply voltage waveform between power supply terminals of the load 206 or a wattmeter that acquires an instantaneous power waveform.

As illustrated in FIG. 18A, the failure sign detection unit 101 may acquire current waveform information by using a communication unit 1010 that communicates with the communication unit 204 in the measuring instrument 200 directly or via a communication network.

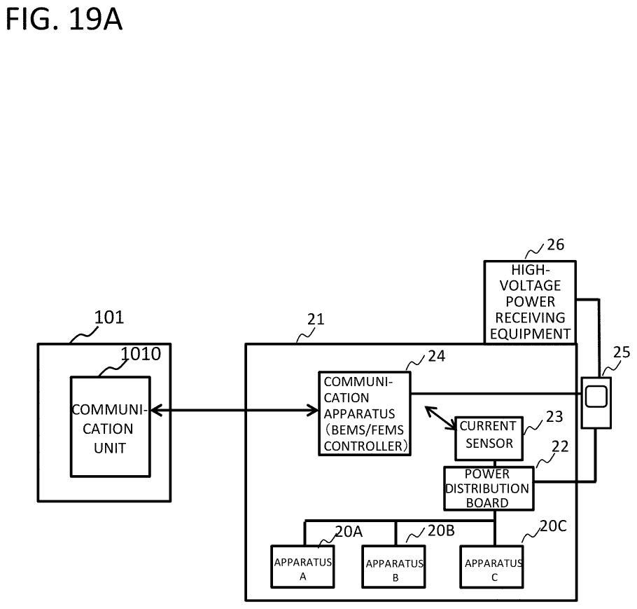

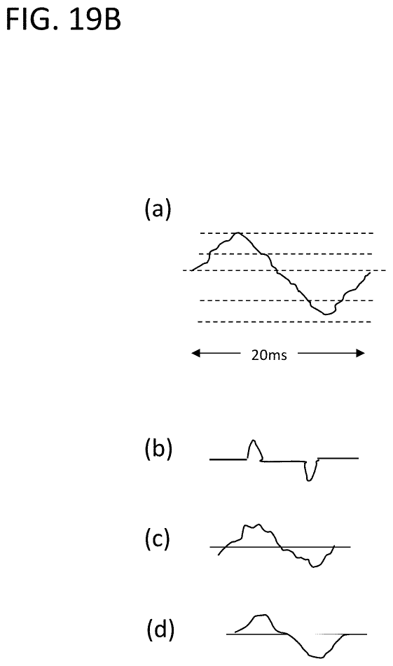

FIG. 19 illustrates an example in which the failure sign detection unit 101 in FIG. 1 performs disaggregation of the total power supply current of a plurality of apparatuses and acquires the power supply currents of the respective apparatuses. As illustrated in FIG. 19A, a communication apparatus (a BEMS/FEMS controller) 24 in a building 21 such as a factory or a store acquires measured data (power consumption or the like) of a smart meter 25 via route B, for example. The measured data (power consumption, a current value, or the like) acquired by the communication apparatus 24 from the smart meter 25 via route B includes information on power consumption at the whole building. Alternatively, a current sensor 23 that detects a current flowing through a main breaker (not illustrated) connected to a main power line of a power distribution board 22 or a branch breaker(s) (not illustrated) may be arranged in at least one of the main breaker and the branch breaker(s), and current waveform data may be transmitted from the current sensor 23 to the communication apparatus 24 via wireless transmission or the like. The current sensor 23 may include a current transformer (CT) (for example, a zero-phase-sequence current transformer (ZCT)) or a Hall element, for example. The current sensor 23 may use an A/D converter (not illustrated) to sample current waveforms (analog signals) and convert the current waveforms into digital signals, use an encoder (not illustrated) to perform compression coding, and wirelessly transmit the resultant signals to the communication apparatus 24 via a wireless smart utility network (Wi-SUN) or the like. The current waveforms from the communication apparatus 24 are received by the communication unit 1010 in the failure sign detection unit 101. A waveform (a) in FIG. 19B illustrates an example of a synthesized power supply current waveform (a total power supply current waveform) acquired by the current sensor 23 connected to the main breaker or branch breakers (not illustrated) of the power distribution board 22 in FIG. 19A.

The failure sign detection unit 101 may disaggregate data of the synthesized power supply current waveform (the total power supply current waveform) in (a) of FIG. 19B acquired by the communication unit 1010 into the power supply current waveforms of the apparatuses 20A to 20C connected to the main breaker or branch breakers of the power distribution board 22, by using a technique in NPL 1, 2, or the like, for example. In FIG. 19, waveforms (b) to (d) represent the power supply current waveforms of the respective apparatuses 20A to 20C obtained by disaggregating the data of the synthesized power supply current waveform.

The failure sign detection unit 101 may acquire the power supply currents of the apparatuses 20A to 20C from the measured data (the power consumption, current values, etc.) acquired from the smart meter 25 via route B and transmitted from the communication apparatus 24 to the communication unit 1010. For example, of all the measured data from the smart meter 25, the current value data that changes over time may be analyzed by using analysis means such as machine learning or signal processing technology. In this way, the power supply currents of the respective apparatuses can be acquired.

In FIG. 1, among the sensors 210, a vibration sensor including a piezoelectric sensor, for example, may be attached to a monitoring target apparatus to detect mechanical vibration of the apparatus. As in the case of the ammeter 201 in FIG. 18A, an analog signal outputted by a piezoelectric element of the vibration sensor is converted into a digital signal and is transmitted to the failure sign detection unit 101 via the communication part.

In addition, among the sensors 210, an image sensor including a charge-coupled appliance (CCD) camera, for example, may acquire image information about a monitoring target to transmit the image information to the failure sign detection unit 101. For example, an image sensor which is installed at a succeeding stage of a production (machining or processing) apparatus in a factory line and which is implemented on an inspection apparatus that inspects production (machining or processing) results based on images thereof may be used. For example, there are cases in which visual inspection apparatuses are installed. Such a visual inspection apparatus inspects the external appearance of an individual product after a print process, a mount process, or a reflow process in a surface mount technology (SMT) line or the like based on images. When the image sensors of these visual inspection apparatuses are used as the image sensors, the failure sign detection unit 101 may use image data or inspection results acquired by the visual inspection apparatuses. Alternatively, an image sensor that acquires moving images of a robot or the like installed at a production line and monitors an operation of the robot (for example, a trajectory of a robot arm or the like) may be used. In this case, the failure sign detection unit 101 may detect, as a sign of a failure, a variation or an abnormality of a trajectory of the robot arm or the like from the moving images.

The failure sign detection unit 101 may acquire a power supply current waveform, vibration waveform, or image information of the monitoring target apparatus by polling or the like. Alternatively, the failure sign detection unit 101 may always acquire the above waveform or information continuously in real time at predetermined time intervals (for example, on second time scale such as per second). The following describes detection of a sign of a failure based on a current waveform.

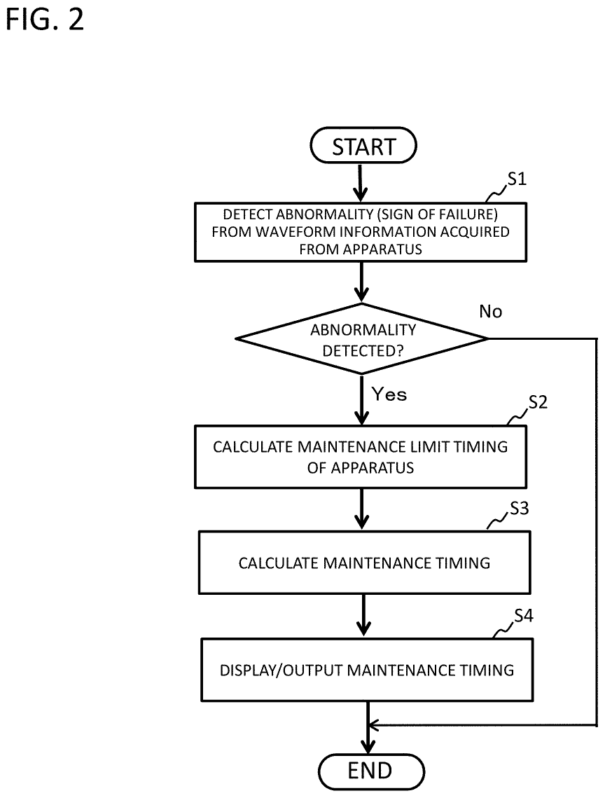

FIG. 2 is a flowchart illustrating an operation of the maintenance plan formulation device 100 in FIG. 1. The failure sign detection unit 101 acquires current waveforms of a monitoring target apparatus and detects a sign of failure of the monitoring target apparatus (step S1). As described above, in step S1, the failure sign detection unit 101 may individually acquire current waveform from a measuring instrument connected to an individual apparatus forming a production line. Alternatively, the failure sign detection unit 101 may perform disaggregation of a current waveform acquired by a main breaker of a power distribution board or a current sensor connected to a branch breaker and acquire power supply current waveforms of a plurality of apparatuses connected to the main breaker or a branch breaker.

The failure sign detection unit 101 may detect an abnormality indicating a sign that appears before a failure of an apparatus occurs, by extracting a feature amount of an acquired power supply current waveform of the monitoring target apparatus and comparing the feature amount with a predetermined threshold.

In addition, when the failure sign detection unit 101 detects an abnormality that appears before a failure of an apparatus occurs and when the failure sign detection unit 101 detects an abnormality that appears before a failure of an apparatus occurs by comparing a feature amount with a predetermined threshold, a method such as machine learning may be used. For example, as the machine learning, at least one of the following may be used:
Support Vector Machine (SVM),
k-Nearest Neighbor Method (k-NN method),
k-Means Clustering Method (k-Means method),
Neural Network (NN),
Local Outlier Factor Method (LOF method), and so forth.

If the failure sign detection unit 101 has detected an abnormality that appears before a failure of an apparatus occurs, the maintenance limit timing calculation unit 102 calculates the maintenance limit timing of the apparatus (step S2). If the failure sign detection unit 101 has not detected an abnormality that appears before a failure of an apparatus occurs, the failure sign detection unit 101 may perform detection of a sign of a failure of a next apparatus.

The maintenance timing calculation unit 103 calculates a maintenance timing, for example, based on a maintenance limit timing calculated for each of one or more apparatuses, by taking reduction of the overall number of times of maintenance operations and reduction of a stoppage time of the corresponding production line by the maintenance operations (operation efficiency and productivity of the production line), or the like, into consideration (step S3).

In step S3, if a time period (maintenance grace period) from the detection of a sign of a failure of an apparatus to the maintenance limit timing includes:
a non-operating period of the apparatus or the line including the apparatus; or
a production stage replacement period of the line including the apparatus,
   the maintenance timing calculation unit 103 may set the maintenance timing of this apparatus so that the maintenance timing overlaps the non-operating period or the production stage replacement period, for example, based on production management information about the production management system.

Alternatively, in step S3, if a first maintenance grace period calculated for a first apparatus, temporally overlaps a second maintenance grace period calculated for a second apparatus, the maintenance timing calculation unit 103 may set a common maintenance timing for the first and second apparatuses. That is, the maintenance timing calculation unit 103 may set a common maintenance timing for the first and second apparatuses in a time (period) in which the first maintenance grace period calculated for the first apparatus temporally overlaps the second maintenance grace period calculated for the second apparatus. As a result, maintenance operations can be performed on the first and second apparatuses in a single maintenance timing that has been set. The maintenance timing common to the first and second apparatuses may be set based on one of the first and second apparatuses that requires a longer maintenance operation time within the time period in which the first and second maintenance grace periods temporally overlap each other.

The maintenance timing output unit 104 outputs the calculated maintenance timing to the display apparatus or the like (step S4). The maintenance timing output unit 104 may display or output the calculated maintenance timing on or to a printer (not illustrated), a storage apparatus (not illustrated), or another host or terminal (not illustrated) via a network (not illustrated), for example.

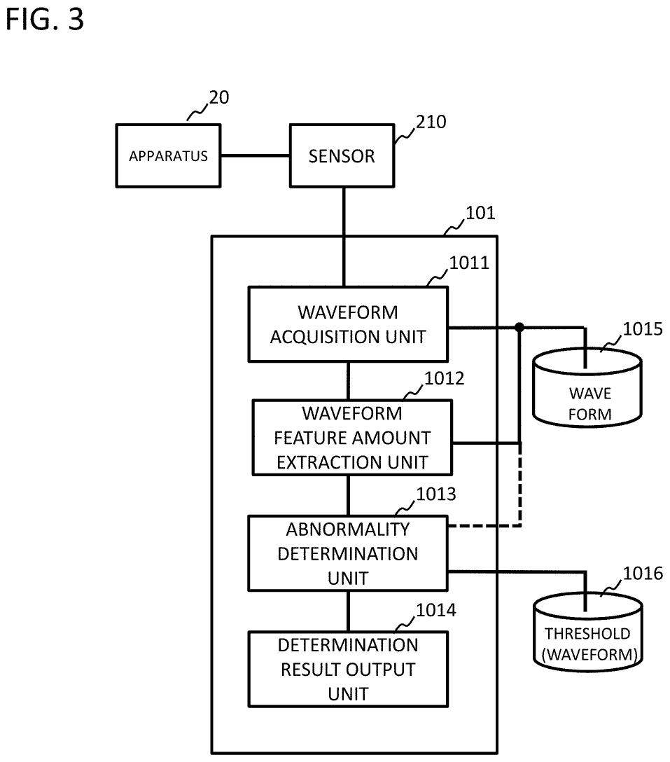

FIG. 3 illustrates an example of an arrangement of the failure sign detection unit 101 in FIG. 1. As illustrated in FIG. 3, the failure sign detection unit 101 includes a waveform acquisition unit 1011, a waveform feature amount extraction unit 1012, an abnormality determination unit 1013, a determination result output unit 1014, and a storage apparatus 1015 such as a random access memory or an HDD.

The waveform acquisition unit 1011 acquires a current waveform or the like from a sensor 210 that acquires a power supply current or the like of a monitoring target apparatus 20, as a state thereof and stores the acquired current waveform in the storage apparatus 1015. After the waveform acquisition unit 1011 acquires a current waveform or the like, the waveform acquisition unit 1011 transfers control to the waveform feature amount extraction unit 1012.

The waveform feature amount extraction unit 1012 reads the current waveform acquired by the waveform acquisition unit 1011 and stored in the storage apparatus 1015. The waveform feature amount extraction unit 1012 extracts a feature amount of the current waveform from the current waveform read from the storage apparatus 1015. In FIG. 3, simply for ease of description, the waveform acquisition unit 1011 stores a current waveform or the like acquired from a sensor 210 in the storage apparatus 1015, and the waveform feature amount extraction unit 1012 reads the current waveform stored by the waveform acquisition unit 1011 in the storage apparatus 1015. However, alternatively, a storage apparatus (not illustrated) inside the waveform acquisition unit 1011 may, as a matter of course, delivers the acquired current waveform to a storage apparatus (not illustrated) inside the waveform feature amount extraction unit 1012. The waveform feature amount extraction unit 1012 may store the extracted feature amount in the storage apparatus 1015 in association with the corresponding current waveform. The waveform feature amount extraction unit 1012 delivers the feature amount extracted from the current waveform to the abnormality determination unit 1013.

The abnormality determination unit 1013 compares the feature amount of the current waveform with a threshold stored in a storage apparatus 1016, determines whether the state of the apparatus represents an abnormality indicating a sign of a failure, and delivers the determination result to the determination result output unit 1014.

If the determination result output unit 1014 receives the determination result indicating an abnormality from the abnormality determination unit 1013, the determination result output unit 1014 notifies the maintenance limit timing calculation unit 102 that a sign of a failure has been detected.

The threshold stored in the storage apparatus 1015 is set to be lower than a level at which a failure is determined. By detecting abnormality of a state of the apparatus using this threshold, the failure sign detection unit 101 detects a sign that appears before a failure of an apparatus occurs.

In addition, when whether a state of the apparatus represents an abnormality indicating a sign of a failure is determined by causing the abnormality determination unit 1013 to compare the feature amount of the current waveform with a threshold stored in the storage apparatus 1016 and when whether the state of the apparatus represents an abnormality indicating a sign of a failure is determined, a method such as machine learning may be used. For example, as the machine learning, at least one of the following may be used:
Support Vector Machine (SVM),
k-Nearest Neighbor Method (k-NN method),
k-Means Clustering Method (k-Means method),
Neural Network (NN),
Local Outlier Factor Method (LOF method), and so forth.

In FIG. 3, the waveform feature amount extraction unit 1012 may calculate a feature amount used as an abnormality index, by extracting a portion of a current waveform with a window function as a feature amount of the current waveform, transforming the portion into a frequency domain by performing Fourier Transform (for example, FFT (Fast Fourier Transform) or DFT (Discrete Fourier Transform)) on the portion, and taking frequency spectrum information into consideration.

For example, in the case of an inverter apparatus including a capacitor-input-type rectifying circuit (a rectifying circuit and a smoothing capacitor), a pulsed current flows through the smoothing capacitor only during charging. Thus, since a sine wave of an AC power supply current and the pulsed waveform are synthesized, harmonic components are generated (frequency components of integral multiples of a commercial power frequency (basic frequency: 50 Hz, for example)).

For example, a motor and a load portion each generate an intrinsic frequency when operated. Thus, when deterioration or an abnormality occurs, the intrinsic frequency may change, and the changed frequency mechanically resonates. As a result, harmonic components are included in the power supply current. By analyzing these harmonic components, the location of the abnormality or the deterioration of the apparatus or the cause thereof is determined.

The waveform feature amount extraction unit 1012 may use, as a frequency domain feature amount, a strength (amplitude) or phase of harmonic frequency component of a specific order such as second-order and fourth-order harmonic frequency components, a sum of the strengths (amplitudes) or phases, a difference among the strengths (amplitudes) or phases, a square of the strengths of the harmonic frequency components of a specific certain orders, the sum of the squares, or the like. Alternatively, the waveform feature amount extraction unit 1012 may use, as the frequency domain feature amount, a distortion (harmonic distortion) based on the sum of the squares of the strengths of harmonic frequency components, a total harmonic distortion (THD), or the like. As the frequency domain feature amount, a sum of strengths (amplitudes) of harmonic frequency components of even-numbered orders equal to or less than a Nyquist frequency and a DC component or the sum of the squares may be used. Alternatively, a sum of the strengths (amplitudes) of harmonic frequency components of odd-numbered orders equal to or less than a Nyquist frequency or the sum of the squares may be used.

If the calculated feature amount exceeds a threshold, the abnormality determination unit 1013 determines that there is an abnormality.

Alternatively, the waveform feature amount extraction unit 1012 may use the current waveform in the selected portion itself as the feature amount. In this case, the abnormality determination unit 1013 stores waveform patterns that include harmonic frequency components, noise components, or the like and that could be considered as abnormalities in the storage apparatus 1016 with respect to normal waveforms. The abnormality determination unit 1013 may detect an abnormality by matching a current waveform, which has been acquired by the waveform acquisition unit 1011 and stored in the storage apparatus 1015, against the waveforms and patterns in the storage apparatus 1016. Alternatively, the abnormality determination unit 1013 may detect an abnormality by previously storing normal waveform patterns in the storage apparatus 1016 and by causing the abnormality determination unit 1013 to compare and match a current waveform, which has been acquired by the waveform acquisition unit 1011 and stored in the storage apparatus 1015, with and against the normal waveform patters in the storage apparatus 1016.

If the waveform acquisition unit 1011 is caused to match the acquired waveform against the waveforms and patterns stored in the storage apparatus 1016, a method such as machine learning may be used. For example, as the machine learning, at least one of the following may be used:
Support Vector Machine (SVM),
k-Nearest Neighbor Method (k-NN method),
k-Means Clustering Method (k-Means method),
Neural Network (NN),
Local Outlier Factor Method (LOF method), and so forth.

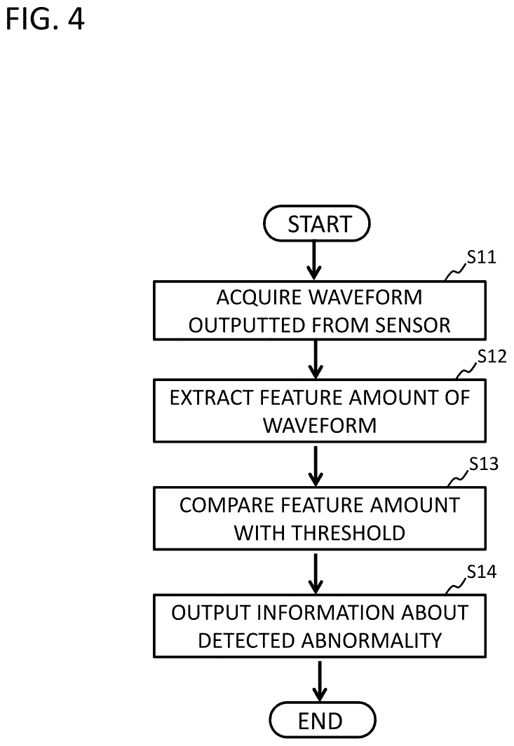

FIG. 4 is a flowchart illustrating an operation of the failure sign detection unit 101 in FIG. 3. As illustrated in FIG. 4, the waveform acquisition unit 1011 acquires a waveform from the sensor 210 (step S11).

The waveform feature amount extraction unit 1012 extracts a feature amount of the power supply current waveform of a monitoring target apparatus (step S12).

The abnormality determination unit 1013 detects an abnormality by comparing the feature amount (a waveform) of the power supply current waveform with a threshold (a pattern) (step S13).

The determination result output unit 1014 receives a determination result obtained by the abnormality determination unit 1013. If an abnormality has been detected, the determination result output unit 1014 notifies the maintenance limit timing calculation unit 102 that a sign of a failure has been detected (step S14).

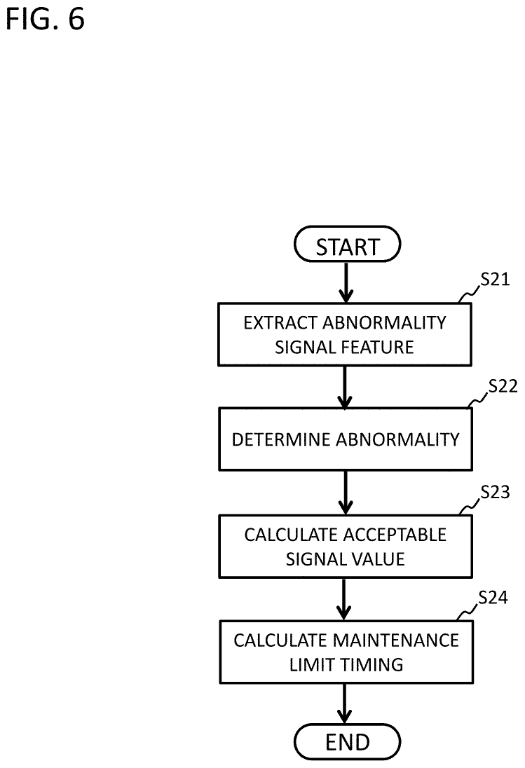

FIG. 5 illustrates an example of an arrangement of a maintenance limit timing calculation unit 102 in FIG. 1. FIG. 6 is a flowchart illustrating an operation of the maintenance limit timing calculation unit 102. As illustrated in FIG. 5, the maintenance limit timing calculation unit 102 includes an abnormality signal feature extraction unit 1020, an abnormality determination unit 1021, an acceptable-signal-value calculation unit 1022, and a maintenance limit timing calculation unit 1023.

The abnormality signal feature extraction unit 1020 extracts an abnormality signal feature.

The abnormality determination unit 1021 determines a kind, a location, a cause, etc. of the detected abnormality, based on logged abnormality information stored in a storage apparatus 1024.

Based on an acceptable value and logged abnormality information related to the determined abnormality, stored in a storage apparatus 1025, the acceptable-signal-value calculation unit 1022 calculates an acceptable value of a signal value (an acceptable signal value) corresponding to the abnormality and stores the calculated acceptable signal value in a storage apparatus 1026. For example, the acceptable value stored in the storage apparatus 1025 may be an acceptable product yield reduction amount in the corresponding production plan or the like. Alternatively, the acceptable value may be, for example, an acceptable fluctuation range (fluctuation check limit) or the like in product quality or the like.

The maintenance limit timing calculation unit 1023 calculates a maintenance limit timing, based on production plan information (for example, plan information indicating until when how many products (lots) need to be produced) stored in the storage apparatus 1027, production result information (for example, information on the number of products (lots) produced so far) stored in a storage apparatus 1028, and the acceptable signal value (corresponding to “maintenance grace limit”) stored in the storage apparatus 1026. The acceptable signal value stored in the storage apparatus 1026 corresponds to, for example, a signal value corresponding to the acceptable product yield reduction amount (a signal value (strength, frequency) corresponding to the degree of the abnormality (deterioration) or the like of the apparatus) and corresponds to a limit until which the needed maintenance operation can be postponed, namely, “maintenance grace limit” described below.

As illustrated in FIG. 6, the abnormality signal feature extraction unit 1020 extracts an abnormality signal feature (step S21). The abnormality signal feature extraction unit 1020 may extract information about the apparatus in which the abnormality has been detected by the failure sign detection unit 101, a location of the apparatus, a kind of the apparatus (for example, an abnormality in a mechanical or electrical system), or the like.

Based on the logged abnormality information stored in the storage apparatus 1024, the abnormality determination unit 1021 determines whether the currently detected abnormality signal feature corresponds to any of the logged abnormality information (step S22). For example, the logged abnormality information stored in the storage apparatus 1024 may include a correspondence relationship (correlation) between the signal value corresponding to a degree of abnormality (deterioration) of the apparatus in which the abnormality has been detected and a production yield (reduction amount) of a product produced by the apparatus. The storage apparatus 1024 may be any storage apparatus that is accessible by the maintenance limit timing calculation unit 102. That is, the storage apparatus 1024 may be arranged outside the maintenance limit timing calculation unit 102. The storage apparatus 1024 holding the logged abnormality information may be a database that holds and manages a production history (log) of a production management system not illustrated.

Based on the logged abnormality information related to the determined abnormality, for example, the acceptable-signal-value calculation unit 1022 calculates an acceptable value of a signal value (an acceptable signal value) corresponding to the acceptable signal value stored in the storage apparatus 1025 and stores the acceptable signal value in the storage apparatus 1026 (step S23). The acceptable signal value stored in the storage apparatus 1025 may be, for example, an acceptable product yield reduction amount in the corresponding production plan or the like. Alternatively, the acceptable signal value may be an acceptable variation or the like in product quality or the like. The acceptable signal value may be a signal value (a signal value (strength, frequency) corresponding to the degree of the abnormality (deterioration) or the like of the apparatus) corresponding to an acceptable product yield reduction amount (an acceptable variation range in product quality or the like).

Based on the production plan information stored in the storage apparatus 1027 and the production result information at the time of the detection of the abnormality stored in the storage apparatus 1028, the maintenance limit timing calculation unit 1023 calculates a maintenance limit timing corresponding to the acceptable signal value stored in the storage apparatus 1026 and stores the calculated maintenance limit timing in the storage apparatus 1029 (step S24).

FIG. 7A is a diagram illustrating the abnormality determination unit 1021 and the acceptable-signal-value calculation unit 1022 in FIG. 5. FIG. 7A is a diagram illustrating a correspondence relationship (for example, a correlation) between the logged abnormality information of an apparatus (a signal value corresponding to the degree of an abnormality) and a production yield (reduction amount) of a product produced by the apparatus. The correspondence relationship (correlation) between a signal value and a production yield (reduction amount) may be obtained by statistically analyzing data of signal values (for example, feature amount of current waveform or frequency of detections of abnormalities) indicating a degree of abnormality of the apparatus in which the abnormality has been detected in the past and a production yield (reduction amount), calculating a correlation coefficient, classifying these according to the kind, location, cause, etc. of the detected abnormality, and storing in advance the data in the storage apparatus 1024. In this case, the signal value and the production yield (reduction amount) about the apparatus in which a current abnormality has been detected may also be included in the previous information in the storage apparatus 1024 as update data.

In FIG. 7A, the X axis is a signal value (strength, frequency) corresponding to the state of the apparatus. The origin on the X axis represents a signal value corresponding to a normal state of the apparatus, for example. The farther from the origin is, the more deteriorated degree of the abnormality will be. When the acceptable signal value is exceeded, the apparatus is considered to be in a failure state. A signal value on the X axis may be an arbitrary value that reflects a state of deterioration of a corresponding apparatus. For example, a signal value on the X axis may be a frequency of detections of abnormalities of the corresponding apparatus (for example, a frequency per unit period). Alternatively, a signal value on the X axis may be a feature amount of a power supply current waveform acquired by a current sensor from the corresponding apparatus (the strength of the frequency spectrum in a frequency domain, the sum of the squares of the strength, the THD, or the like).

In FIG. 7A, the Y axis is a reduction amount of a production yield of a corresponding product produced by the corresponding apparatus in the past. For example, the yield can be obtained as follows:

Yield=number of non-defective products/total number of produced products×100%

In FIG. 7A, to reflect the degree of a state of abnormality of the apparatus, the Y axis is a production yield reduction amount, and the origin on the Y axis is a normal value. The higher the value on the Y axis is, the more deteriorated the production yield (reduction amount) of the products produced by the apparatus will be. For example, the production yield (reduction amount) of a product can be obtained as follows:

Percentage of defective products=number of defective products/total number of produced products×100 (%)

The percentage of the defective products+the yield=100%. When the percentage of the defective products is 10%, the yield is 90%.

In FIG. 7A, different items of abnormality information in the past (each item being a correspondence between a signal value indicating an abnormality state and the percentage of defective products) about kind, the location (apparatus), cause, etc. of the abnormality detected by the failure sign detection unit 101 are represented (plotted) as graphs (1) to (3). In FIG. 7A, simply for ease of description, graphs (1) to (3) are represented as straight lines.

Graphs (straight lines) (1) to (3) may be graphs corresponding to apparatuses A to C, respectively, as abnormality locations. A correspondence between a history (log) of abnormality information about an individual apparatus and a production yield of a product when the product is produced (processed) by using the corresponding apparatus may be stored in the storage apparatus (1024 in FIG. 5). Alternatively, an expression(s) (coefficients of polynomials) that approximates the above correspondence with a curve (polynomial or the like) may be stored in advance in the storage apparatus (1024 in FIG. 5). Alternatively, correlation coefficients about the above correspondence may be stored in advance in the storage apparatus (1024 in FIG. 5).

When graphs (straight lines) (1) to (3) correspond to the apparatuses A to C as abnormality locations, for example, if the failure sign detection unit 101 detects an abnormality in the apparatus B, the abnormality determination unit 1021 selects graph (2). The acceptable-signal-value calculation unit 1022 calculates an acceptable signal value from the X coordinate of an intersection at which the acceptable value (Y axis) of the production yield (reduction amount) previously stored in the storage apparatus 1025 and graph (2) intersect.

Alternatively, graphs (straight lines) (1) to (3) in FIG. 7A may be graphs corresponding to different kinds of abnormalities of the same apparatus A. When the failure sign detection unit 101 detects an abnormality of the apparatus A, the abnormality determination unit 1021 determines the kind of abnormality from a feature amount of a waveform and selects, for example, graph (2) corresponding to the determined kind of abnormality. The acceptable-signal-value calculation unit 1022 calculates an acceptable signal value from the X coordinate of an intersection at which the acceptable value (Y axis) of the production yield and graph (2) intersect.

FIG. 7B schematically illustrates processing of the maintenance limit timing calculation unit 1023. In FIG. 7B, the X axis is date, and the Y axis is a signal value on the X axis in FIG. 7A and indicates an acceptable signal value obtained in FIG. 7A. Regarding a current date (it may be a date when an abnormality is detected in an apparatus), from the production plan information (how many lots of corresponding products need to be produced and until when these lots need to be produced) and production result information (the number of lots produced up until now), a signal value transition curve is calculated, and the X coordinate of the intersection at which the acceptable signal value and the curve intersect is determined to be “maintenance limit timing”. The maintenance limit timing may be a specific time (hour) (for example, a certain time on a certain date in a certain month), instead of using “date” as a unit. The maintenance limit timing may of course be a value including a predetermined time duration, depending on the production line, the apparatus, the production plan, etc.

In FIG. 7B, the signal value on the Y axis may have a positive correlation with the number of produced products (lots), for example. In FIG. 7B, when the signal value on the Y axis is, for example, a frequency (a frequency of detections of abnormalities), if more production lots need to be produced from a current date, heavier load will be placed on the apparatus, and the apparatus will be deteriorated more quickly. As a result, the frequency of detections of abnormalities, which is a signal value from the current date, tends to rise. Thus, the curve of the signal value from the current date has a larger slope, and the maintenance limit timing, which is the X coordinate of the intersection of the acceptable signal value and the curve, comes closer to the current date. When the signal value on the Y axis is a signal strength (a feature amount of a power supply current waveform of an apparatus, the feature amount reflecting an abnormality degree), if more production lots need to be produced from the current date, heavier load will be placed on the apparatus, and the apparatus will be deteriorated more quickly. That is, in this case, the curve of the signal value has a larger slope, and the maintenance limit timing, which is the X coordinate of an intersection at which the acceptable signal value and the curve intersect, comes closer to the current date.

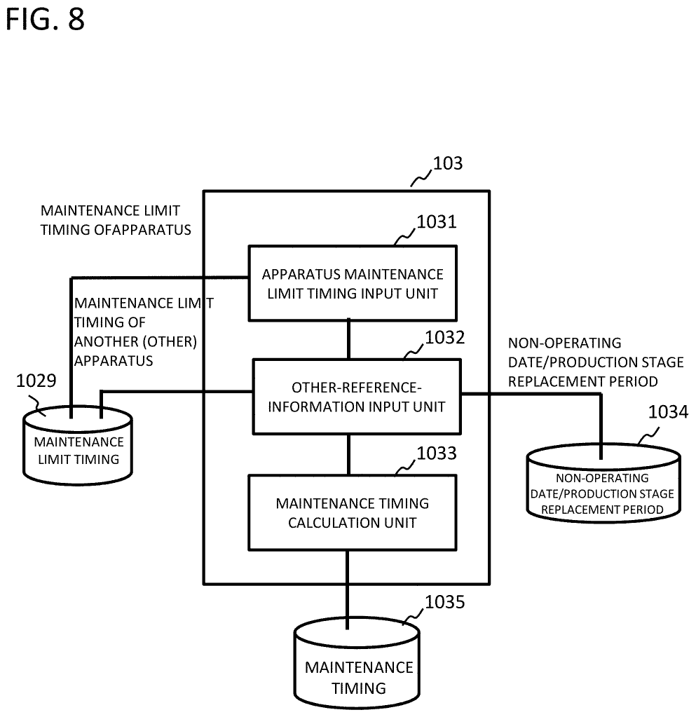

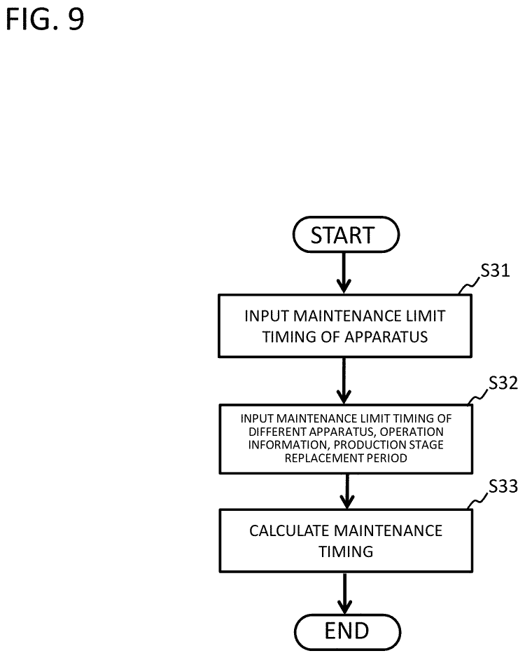

FIG. 8 illustrates an example of an arrangement of the maintenance timing calculation unit 103 in FIG. 1. FIG. 9 is a flowchart illustrating an operation of the maintenance timing calculation unit 103.

As illustrated in FIG. 8, the maintenance timing calculation unit 103 includes an apparatus maintenance limit timing input unit 1031, an other-reference-information input unit 1032, and a maintenance timing calculation unit 1033.

As illustrated in FIG. 9, the apparatus maintenance limit timing input unit 1031 receives the maintenance limit timing from the storage apparatus 1028 of the maintenance limit timing calculation unit 102 (step S31).

The other-reference-information input unit 1032 receives a maintenance limit timing of each of one or more other apparatuses from the storage apparatus 1029 holding the maintenance limit timing (maintenance grace period end date) received from the maintenance limit timing calculation unit 102 and receives information about a non-operating date of the apparatus (the line, the factory, etc.), a production stage replacement period of the line, etc. from a storage apparatus 1034 (step S32).

The maintenance timing calculation unit 1033 calculates a maintenance timing based on the received information (step S33).

The maintenance timing calculation unit 1033 may set a single maintenance timing for the apparatuses within a time period in which the maintenance grace periods of the plurality of apparatuses forming a production line temporally overlap each other.

If the non-operating period (non-operating date) or the production stage replacement period of the production line is later than the time at which the abnormality has been detected in the apparatus and is earlier than the maintenance limit timing of the apparatus, the maintenance timing calculation unit 1033 may set a maintenance timing of the single apparatus or the maintenance timings of a plurality of apparatuses in the non-operating period (the non-operating day) or the production stage replacement period.

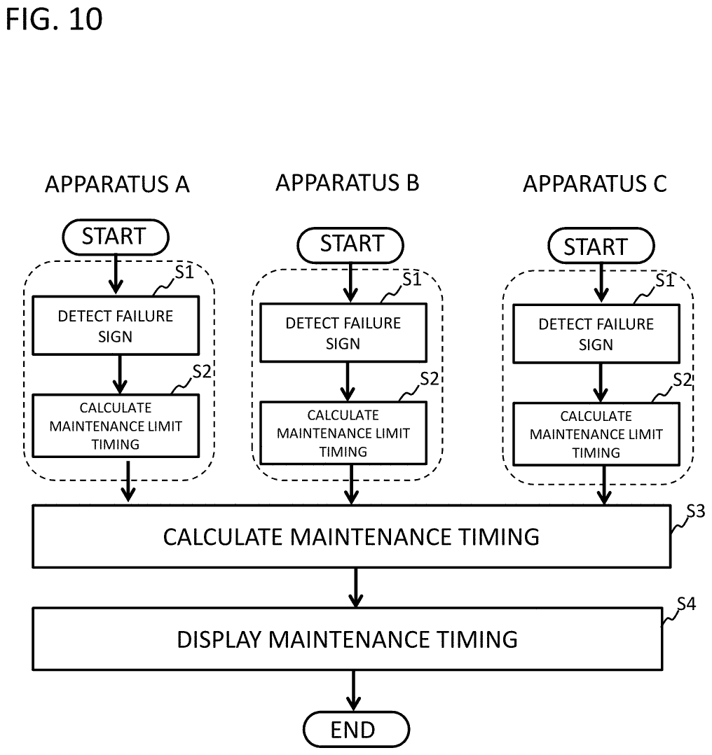

FIG. 10 illustrates the example embodiment illustrated in FIG. 1. While FIG. 10 illustrates processing on the apparatuses A to C, the number of apparatuses is, as a matter of course, not limited to 3.

Failure sign detection processing (step S1) is performed on an individual one of the apparatuses A to C, and the maintenance limit timings are calculated for the respective apparatuses A to C (step S2).

Based on the maintenance limit timings calculated for the respective apparatuses A to C and other information (a non-operating day, a production stage replacement period, etc.), the maintenance timing calculation unit 103 calculates a maintenance timing(s) (step S3). The maintenance timing output unit 104 displays the maintenance timing (step S4).

FIG. 10 illustrates, simply for the description, an example in which an abnormality has been detected in an individual one of the apparatuses A to C. If an abnormality has been detected in a certain apparatus and if, after this abnormality of the apparatus is detected, a maintenance limit timing of the other apparatus(es) does not exist in a period (maintenance grace period) before the maintenance limit timing of the apparatus (if the maintenance limit timing of the apparatus does not overlap), a maintenance operation on the apparatus is performed at a maintenance timing within the maintenance grace period of the apparatus. However, in this case, when the maintenance timing is set for the apparatus, if the maintenance limit timing of the other apparatus(es) temporally comes after the maintenance grace period of the apparatus, the maintenance operations on the apparatus and the other apparatus(es) may be performed at the same maintenance timing set within the maintenance grace period of the apparatus. In contrast, if the maintenance limit timing of at least one other apparatus exists within the maintenance grace period of the apparatus, a maintenance timing may be set within a time period in which the maintenance grace periods of the other apparatus(es) and the apparatus temporally overlap, and maintenance operations may be performed on the other apparatus(es) and the apparatus at this same maintenance timing.

In addition, for example, if a non-operating period or a production stage replacement period exists within the maintenance grace period of the apparatus, a maintenance operation may be performed on the apparatus in the non-operating period or the production stage replacement period. In this case, the non-operating period or the production stage replacement period may not include the whole maintenance timing of the apparatus (the length of the non-operating period or the production stage replacement period<the maintenance timing). That is, the non-operating period or the production stage replacement period may overlap only a part of the maintenance timing of the apparatus. If a non-operating period or a production stage replacement period does not exist within the maintenance grace period of the apparatus, a maintenance operation may be performed on the apparatus as needed. In addition, if there are a plurality of apparatuses whose maintenance grace periods temporally overlap a non-operating period or a production stage replacement period, maintenance operations may be performed on the plurality of apparatuses in the non-operating period or the production stage replacement period.

### Comparison with Comparative Example

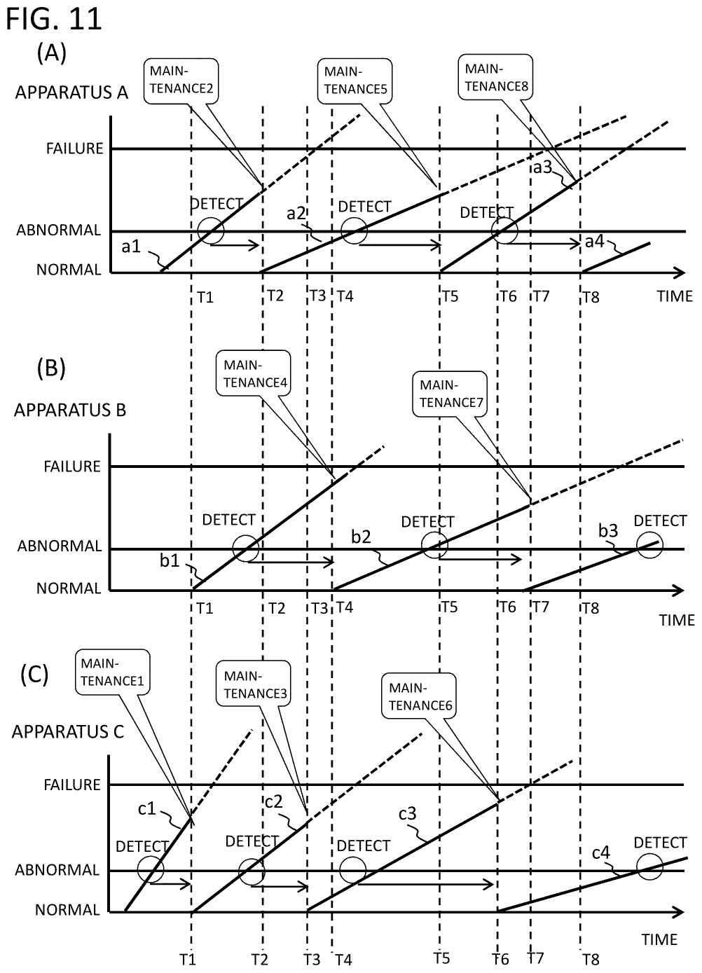

FIG. 11 illustrates a comparative example. FIG. 12 illustrates an application example of the present invention. In the example in FIG. 11, as-needed maintenance operations are performed when abnormalities are detected in apparatuses. The following example will be described with respect to the passage of time. For example, the example in FIG. 11 assumes that a maintenance operation on an apparatus is performed a certain period of time after a sign of a failure is detected in the apparatus. In each of (A) to (C) of FIG. 11, a horizontal axis is time, which is common among (A) to (C) in FIG. 11. A vertical axis is levels of a signal value that can be classified to normality, abnormality, and failure of the corresponding apparatus (the vertical axis may be abnormality occurrence frequency or the like of the corresponding apparatus). While the abnormality and failure levels on the vertical axis in each of (A) to (C) of FIG. 11 differ, for example, depending on a kind of the apparatus, or, location, kind or cause or the like of abnormality or failure, the same abnormality and failure levels will be used in (A) to (C) of FIG. 11, for simplicity. For ease of description, FIG. 11 illustrates an example in which an abnormality is detected in each of the apparatuses A to C.

In (A) of FIG. 11, each of graphs a1 to a4 represents a signal value, extending from “normal” with a certain slope. In other words, each graph represents temporal transition of a state (state such as normality, abnormality, or failure.) of the apparatus A as a continuous straight line having a constant slope. Each of graphs a1 to a4 corresponds to the graph of the signal value in FIG. 7B. Generally, the temporal transition of a state of the apparatus A does not linearly change over time but fluctuates in various manners, e.g., in a discontinuous manner. However, in FIG. 11, only for simplicity, the temporal transition is represented as a straight line. Circles on the graphs (straight lines) a1 to a4 represent points corresponding to when the signal value of the apparatus A has exceeded an abnormality level (a threshold) (a point when an abnormality is detected). Each circle corresponds to when the abnormality determination unit 1013 of the failure sign detection unit 101 has detected that a current waveform feature amount has exceeded a threshold in FIG. 3, for example.

In the comparative example, a maintenance operation on the apparatus A is performed when a predetermined time period has elapsed after an abnormality was detected. The predetermined time period may be a value set per apparatus. That is, different values may be set for the respective apparatuses. As illustrated in (A) of FIG. 11, a maintenance operation on the apparatus A is performed at time T2 (or on a date, for example), when a certain time (a predetermined time) has elapsed after an abnormality was detected. As a result, the state of the apparatus A returns to “normal”, and the temporal transition of the state of the apparatus A is next represented by graph (straight line) a2. An extension (indicated in a dashed line) of graph (straight line) a1 after time T2 represents a virtual temporal transition of the state of the apparatus A, if the maintenance operation had not been performed at time T2. After an abnormality is detected, if the apparatus A is continuously operated without a maintenance operation, the state indicates “failure”. A maintenance operation on the apparatus is performed before the state of the apparatus indicates “failure”. Detection of an abnormality and execution of a maintenance operation in each of temporal transitions b1 to b3 and c1 to c4 about the states of the apparatuses B and C in (B) and (C) of FIG. 11 are the same as those in graphs a1 to a4 in (A) of FIG. 11. In (A) to (C) in FIG. 11, simply for ease of description, the same abnormality level (a value on the Y axis) for detecting an abnormality is used. However, different values may of course be used for the apparatuses A to C depending on the kinds of the apparatuses.

As seen from FIG. 11, eight maintenance operations are performed in total:
1st: a maintenance operation on the apparatus C at time T1,
2nd: a maintenance operation on the apparatus A at time T2,
3rd: a maintenance operation on the apparatus C at time T3,
4th: a maintenance operation on the apparatus B at time T4,
5th: a maintenance operation on the apparatus A at time T5,
6th: a maintenance operation on the apparatus C at time T6,
7th: a maintenance operation on the apparatus B at time T7, and
8th: a maintenance operation on the apparatus A at time T8.
   If the apparatuses A to C form a production line, each time a maintenance operation is performed on an apparatus, the production line needs to be stopped (eight times in total).

In contrast, as illustrated in FIG. 12 in which the present example embodiment is described, a common maintenance timing is calculated for the apparatuses A to C. At the common maintenance timing, maintenance operations are performed on the apparatuses A to C. If the apparatuses A to C form a production line, the production line needs to be stopped four times in total due to the maintenance operations on the apparatuses. The present example embodiment can improve efficiency in an operation of the production line than the comparative example in FIG. 11 (where the production line needs to be stopped eight times in total).

As in the comparative example in FIG. 11, FIG. 12 illustrates as-needed maintenance operations, which are performed when abnormalities are detected in apparatuses, with respect to the passage of time. In (A) to (C) of FIG. 12, the horizontal axis represents time, which is common among (A) to (C) in FIG. 12. The vertical axis in each of (A) to (C) of FIG. 12 represents levels of a signal value that can be classified to normality, abnormality, and failure of the corresponding apparatus, as in (A) to (C) of FIG. 11. While the abnormality and failure levels on the vertical axis in each of (A) to (C) of FIG. 12 may differ, for example, depending on a kind of the apparatus, a location, a kind, a cause or the like of the abnormality or failure, the same abnormality or failure levels will be used for simplicity. For ease of description, FIG. 12 illustrates an example in which an abnormality is detected in each of the apparatuses A to C.

In (A) of FIG. 12, graph a1 represents a signal value, extending from “normal” with a certain slope. In other words, graph a1 represents temporal transition of a state (a state such as normality, abnormality, or failure.) of the apparatus A as a continuous straight line having a constant slope. The temporal transition of a state of the apparatus A does not linearly change over time but fluctuates in various manners, e.g., in a discontinuous manner. However, in FIG. 12, only for simplicity, the temporal transition is represented as a straight line. A circle on graph (a straight line) a1 represents a point corresponding to when the signal value of the apparatus A has exceeded the abnormality level (a threshold). Each circle corresponds to when the abnormality determination unit 1013 of the failure sign detection unit 101 has detected that a current waveform feature amount has exceeded the above threshold in FIG. 3, for example. In (A) of FIG. 12, graphs (straight lines) a1 to a4 have the same slopes as those of graphs (straight lines) a1 to a4 in (A) of FIG. 11.

For example, when the failure sign detection unit 101 detects that a current waveform feature amount of the apparatus A has exceeded the threshold (time: TA2S), the maintenance limit timing calculation unit 102 calculates a maintenance limit timing (time: TA2E). The maintenance limit timing (time: TA2E) corresponds to timing (date) at which a graph (straight line) a1 representing the temporal transition of a state of the apparatus A exceeds the maintenance grace limit (the X coordinate of an intersection at which the extension (a dashed line) of the graph (straight line) a1 and the maintenance grace limit intersect). “The maintenance grace limit” in (A) to (C) of FIG. 12 corresponds to the “acceptable signal value” in FIG. 7B.

Regarding the state of the apparatus A, a period with a starting point set to a time TA2S at which the failure sign detection unit 101 detects an abnormality and with an end point set to the maintenance limit time TA2E is a maintenance grace period.

Regarding the apparatus B in (B) of FIG. 12, too, for example, when the failure sign detection unit 101 in FIG. 1 detects that a current waveform feature amount of the apparatus B has exceeded the threshold (time: TB2S), the maintenance limit timing calculation unit 102 calculates a maintenance limit timing (time: TB2E) of the apparatus B. The period from TB2S to TB2E is a maintenance grace period. In (B) of FIG. 12, graphs (straight lines) b1 to b3 have the same slopes as those of graphs (straight lines) b1 to b3 in (B) of FIG. 11.

Regarding the apparatus C in (C) of FIG. 12, too, for example, when the failure sign detection unit 101 in FIG. 1 detects that a current waveform feature amount of the apparatus C has exceeded the threshold (time: TC2S), the maintenance limit timing calculation unit 102 calculates a maintenance limit timing (time: TC2E) of the apparatus C. The period from TC2S to TC2E is a maintenance grace period. In (C) of FIG. 12, graphs (straight lines) c1 to c4 have the same slopes as those of graphs (straight lines) c1 to c4 in (B) of FIG. 11.

The maintenance timing calculation unit 103 in FIG. 1 calculates a maintenance timing from a time period commonly included in the maintenance grace periods [TA2S, TA2E], [TB2S, TB2E], and [TC2S, TC2E] of the apparatuses A to C in (A) to (C) of FIG. 12. In this calculation, as described above, if a non-operating day, a production stage replacement period, and the like are before the maintenance limit timings of the apparatuses A to C, the maintenance timing calculation unit 103 may calculate a maintenance timing based on information about the non-operating day, the production stage replacement period, and the like. In the example in FIG. 12, maintenance operations are simultaneously performed on the apparatuses B and C at a certain point within the maintenance grace period [TA2S, TA2E] of the apparatus A, which is the maintenance target apparatus. In addition, simply for ease of description, a duration of each of the maintenance operations on the apparatuses is not illustrated in (A) to (C) of FIG. 12, and the maintenance operations bring the apparatuses A to C to their respective normal states at the same timing (time). The apparatuses A to C may, as a matter of course, require different time lengths (maintenance operation time lengths) to complete respective maintenance operation.

As described above, the maintenance timing calculation unit 103 may calculate a common maintenance timing for the apparatus A and one or more other apparatuses (the apparatus B and/or the apparatus C), based on the maintenance grace period (for example, [TA2S, TA2E]) calculated for an apparatus, e.g., the apparatus A in (A) of FIG. 12 and the maintenance grace period(s) calculated for one or more apparatuses (for example, the apparatus B and/or apparatus C in (B) and (C) of FIG. 12) (for example, [TB2S, TB2E] and [TC2S, TC2E] in (B) and (C) of FIG. 12). More specifically, the above common maintenance timing may be preferably set in a time in which the maintenance grace periods of a plurality of apparatuses temporally overlap each other. As a result, maintenance operations can be performed on the plurality of apparatuses in a single maintenance timing. For example, in the example in FIG. 12, for example, by setting a maintenance timing in a time (period) T2 in which the maintenance grace periods of the apparatuses A to C overlap, maintenance operations can be performed on the apparatuses A to C at one time.

In the example in FIG. 12, since the maintenance timings of the apparatuses A to C are maintenance timings 1 to 4, the production line is stopped four times due to the maintenance operations of these apparatuses. That is, compared with the comparative example in FIG. 11, the number of times of stoppage of the production line can be reduced more significantly, and the efficiency of the production line can be improved further.

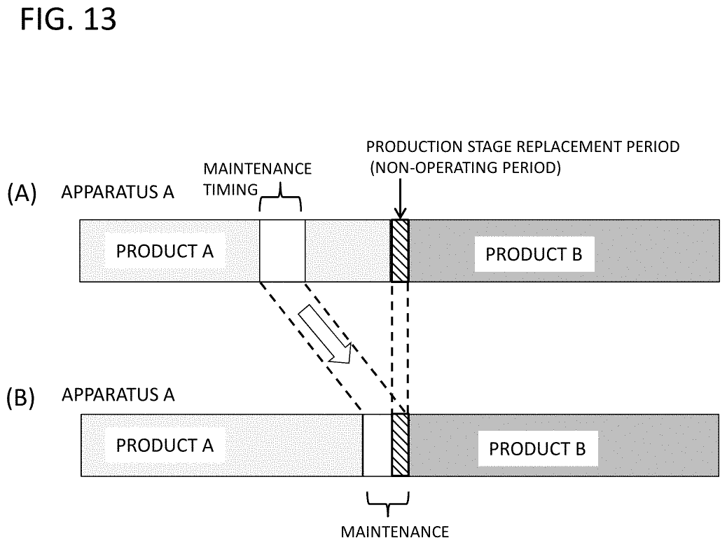

FIG. 13 illustrates the first example embodiment of the present invention. As illustrated in (A) of FIG. 13, the following description assumes that there is a production stage replacement period (a non-operating period) in which a product produced (processed) by the apparatus A is switched from a product A to a product B after a maintenance timing of the apparatus A. In (A) of FIG. 13, the production stage replacement period (the non-operating period) is included in a maintenance grace period of the apparatus A (if a maintenance limit timing of the apparatus A is later than the production stage replacement period (the non-operating period)), as illustrated in (B) of FIG. 13, the maintenance timing of the apparatus A may be set in the production stage replacement period (the non-operating period). By performing a maintenance operation on the apparatus A in the production stage replacement period (the non-operating period), the stoppage time of the production line due to the maintenance operation on the apparatus A can be reduced.

In the example of (A) in FIG. 13, the maintenance time (period) of the apparatus A is longer than a production stage replacement period (non-operating period), In the example of (B) in FIG. 13, the production stage replacement period (the non-operating period) and part of the maintenance time (period) of the apparatus A overlap. However, the production stage replacement period (the non-operating period) may, as a matter of course, be longer than the maintenance time (period) of apparatus A. In addition, if there are a plurality of apparatuses and the maintenance grace periods thereof temporally overlap the production stage replacement period (the non-operating period), the maintenance operations on the plurality of apparatuses may be performed in the non-operating period or the production stage replacement period.

As in (A) to (C) of FIG. 12, (A) to (C) of FIG. 21 illustrate cases in which as-needed maintenance operations are performed when abnormalities are detected in the apparatuses A to C. These cases will be described with respect to the passage of time. A maintenance timing may be determined based on the maintenance limit timings calculated for the apparatuses B and C ((B) and (C) of FIG. 21) and the maintenance limit timing calculated for the apparatus A ((A) of FIG. 21). For example, in the case of maintenance timing 1, a maintenance timing is set at the maintenance limit timing of the apparatus A. Thus, the maintenance timing can be set as late as possible.

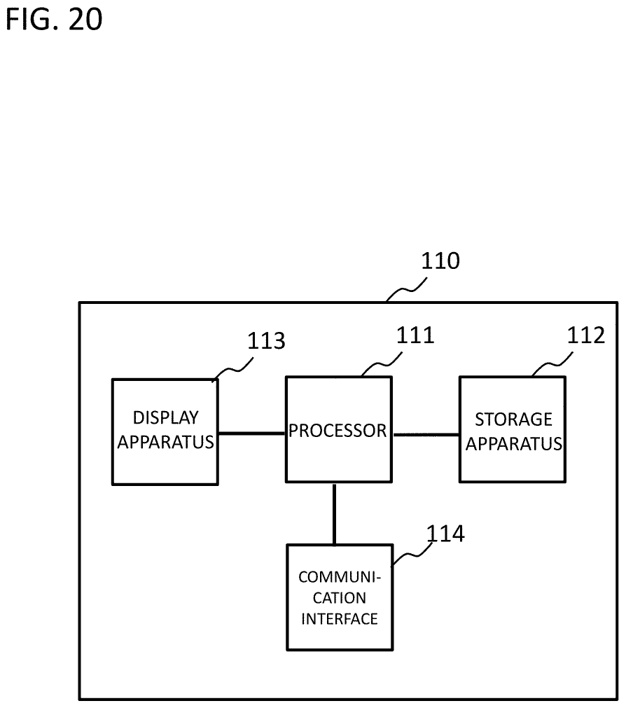

For example, as illustrated in FIG. 20, the maintenance plan formulation device 100 in FIG. 1 may be implemented on a computer system. As illustrated in FIG. 20, a computer system 110 such as a server computer includes, a processor (a central processing unit (CPU), a data processing apparatus) 111, a storage apparatus 112 including at least one of a semiconductor memory (for example, a random access memory (RAM), a read-only memory (ROM), or an electrically erasable and programmable ROM (EEPROM), etc.), a hard disk drive (HDD), a compact disc (CD), a digital versatile disc (DVD), etc., a display apparatus 113, a communication interface 114 that acquires current waveforms acquired by a measuring instrument, a current sensor, etc. via a communication network. The maintenance plan formulation device 100 according to the above example embodiment may be realized by storing a program that realizes the processing of the failure sign detection unit 101, the maintenance limit timing calculation unit 102, the maintenance timing calculation unit 103, and the maintenance timing output unit 104 in FIG. 1 in the storage apparatus 112 and causing the processor 111 to read and execute the program. The maintenance timing output unit 104 of the processor 111 that outputs a maintenance timing to the display apparatus 113 may cause a display part of a terminal (not illustrated) connected to a communication network to display a maintenance timing via the communication interface 114 or may store a maintenance timing in the storage apparatus 112. The computer system 110 may be implemented as a cloud server that provides clients with the maintenance plan formulation service as a cloud service.

According to the present example embodiment, regarding a maintenance operation(s) performed based on a sign(s) of a failure(s) of an apparatus(es), an appropriate maintenance plan can be formulated from a viewpoint of reduction in the stoppage time of a production line, improvement in the productivity, etc.

### SECOND EXAMPLE EMBODIMENT

Next, a second example embodiment of the present invention will be described. The second example embodiment has the same configuration as that according to the first example embodiment described with reference to FIG. 1, etc. Thus, the description of the configuration of the second example embodiment will be omitted. In the first example embodiment, maintenance limit timings are calculated for a plurality of apparatuses based on their respective failure sign detection results, and a common maintenance timing is calculated for a plurality of apparatuses. However, the present invention is also applicable in the same way to a case in which two different abnormalities are detected in a single apparatus. The following description will be made on a case in which, after one abnormality is detected in an apparatus, another abnormality is detected at another location will be described. The following description assumes that the apparatus is formed by a plurality of elements (or by a plurality of appliances, parts, etc.) and that a maintenance plan about the plurality of elements in the same apparatus is formulated.

For example, a mounting apparatus for mounting electronic components on predetermined locations on a printed circuit board includes constituent elements such as an XY stage, a head for adsorbing and carrying electronic components, a feeder arrangement part for supplying electronic components, an image recognition apparatus for positioning the printed circuit board and controlling attachment of electronic components, and a conveyer for conveying the printed circuit board. The maintenance timings may be calculated by detecting signs of failures from the individual constituent elements based on current waveforms, vibration waveforms, or image information about, for example, drive parts such as the XY stage, the feeder part, and the conveyer. The present example embodiment can be realized by regarding the apparatus A and so forth in the above described first example embodiment, respectively, as element 1, element 2, element n, which are the constituent elements of an apparatus. When a plurality of abnormalities are detected in a single constituent element in the apparatus, if the constituent element is formed by a plurality of partial elements and the plurality of abnormalities are detected in a plurality of different partial elements, the second example embodiment is applied to the plurality of partial elements.

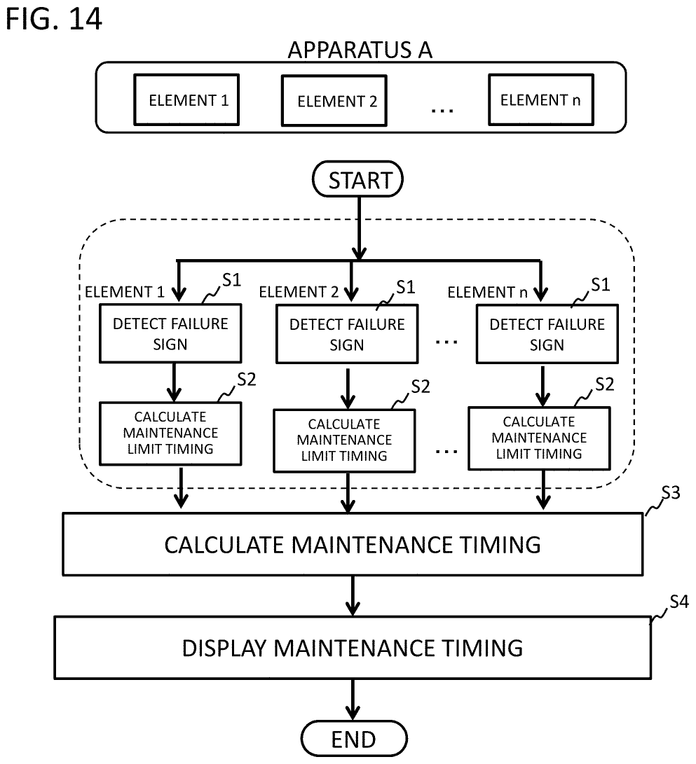

FIG. 14 illustrates the second example embodiment. The failure sign detection unit 101 in FIG. 1 acquires a current supplied to an individual element by using the measuring instrument 200 illustrated in FIG. 18A and performs detection of a sign of a failure on each of the elements 1 to n in the apparatus A (step S1). A maintenance limit timing is calculated for an individual element from which an abnormality has been detect (step S2). For convenience of description, FIG. 14 illustrates a case in which an abnormality is detected in each of elements 1 to n and a maintenance limit timing is calculated for each element. However, if an abnormality is detected in the element 1 and if an abnormality is not detected in any other element before the maintenance limit timing of the element 1, a maintenance operation is performed on the element 1 before the maintenance limit timing of the element 1 or in a non-operating period of the apparatus A, or the like. If maintenance limit timings have been calculated for a plurality of elements, the maintenance timing calculation unit 103 calculates a maintenance timing based on the maintenance limit timings calculated for the elements and other information (a non-operating day, a production stage replacement period, etc.) (step S3). The maintenance timing output unit 104 displays the maintenance timing (step S4).

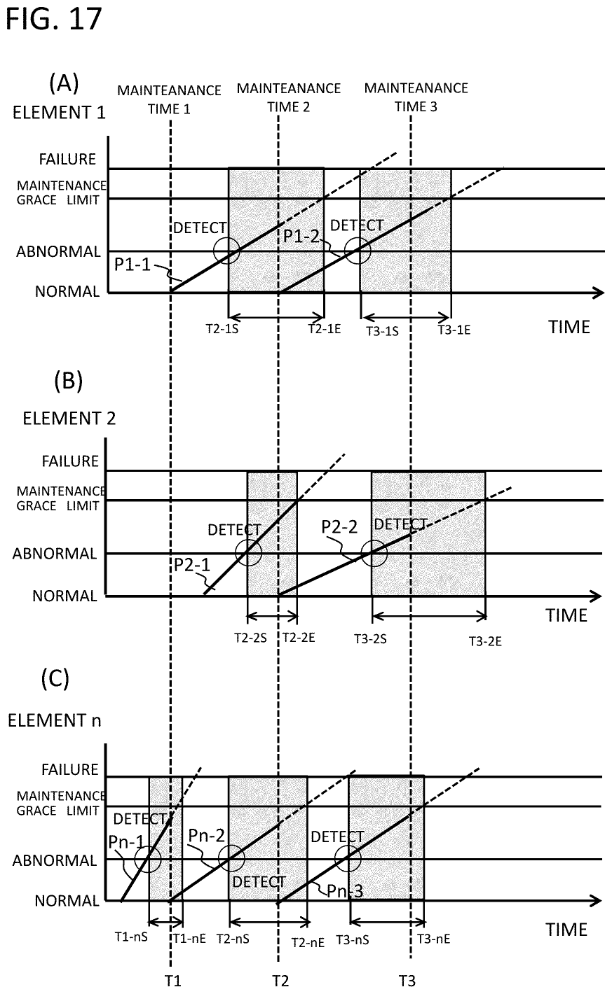

FIG. 17 illustrates an example according to the second example embodiment in which as-needed maintenance operations are performed when abnormalities are detected in elements of the apparatus A. The following example will be described with respect to the passage of time. In addition, FIG. 17 corresponds to the illustration scheme as described with reference to the above FIG. 12. In (A) to (C) in FIG. 17, the horizontal axis represents time, which is common among (A) to (C) in FIG. 17. As in (A) to (C) of FIG. 12, in (A) to (C) in FIG. 17, the vertical axis is a level of a signal value that can be classified to normality, abnormality, and failure of the corresponding element (the vertical axis may represent the abnormality occurrence frequency or the like of the corresponding element). While the abnormality and failure levels on the vertical axis in each of (A) to (C) of FIG. 17 differ, for example, depending on a kind of the element, or, a location, a kind, a cause or the like of abnormality or failure, the same abnormality and failure levels will be used in (A) to (C) of FIG. 17, for simplicity.

In (A) of FIG. 17, graph P1-1 represents a signal value, extending from “normal” with a certain slope. In other words, graph P1-1 represents temporal transition of the state (the state such as normality, abnormality, or failure) of the element 1 as a continuous straight line. The temporal transition of the state of the element 1 does not necessarily constantly change over time but fluctuates in various manners, e.g., in a discontinuous manner. However, in FIG. 17, for simplicity, the temporal transition is represented as a straight line. A circle on graph (a straight line) P1-1 represents a point corresponding to when the signal value of the element 1 has exceeded the abnormality level (a threshold). For example, when the failure sign detection unit 101 detects that a current waveform feature amount of the element 1 has exceeded the threshold (time: T2-1S), the maintenance limit timing calculation unit 102 calculates a maintenance limit timing (time: TA-1E). The maintenance limit timing (time: T2-1E) corresponds to timing (date) at which graph P1-1 representing the temporal transition of the state of the element 1 exceeds the maintenance grace limit. “The maintenance grace limit” in (A) to (C) of FIG. 17 corresponds to the “acceptable signal value” in FIG. 7B. A period with a starting point set to the time T2-1S at which the failure sign detection unit 101 detects the abnormality and with an end point set to the maintenance limit time T2-1E is a maintenance grace period of the element 1.

Regarding the element 2 in (B) of FIG. 17, too, for example, when the failure sign detection unit 101 in FIG. 1 detects that a current waveform feature amount of the element 2 has exceeded the threshold (time: T2-2S), the maintenance limit timing calculation unit 102 calculates the maintenance limit timing (time: T2-2E) for the element 2. A period from T2-2S to T2-2E is the maintenance grace period for the element 2.

Regarding the element n in (C) of FIG. 17, too, for example, when the failure sign detection unit 101 in FIG. 1 detects that a current waveform feature amount of the element n has exceeded the threshold (time: T2-nS), the maintenance limit timing calculation unit 102 calculates a maintenance limit timing (time: T2-nE) for the element n. The period from T2-nS to T2-nE is the maintenance grace period for the element n.

The maintenance timing calculation unit 103 in FIG. 1 calculates a maintenance timing from a time period commonly included in the maintenance grace periods [T2-1S, T2-1E], [T2-25, T2-2E], and [T2-nS, T2-nE] of the elements 1 to n in (A) to (C) of FIG. 17. In this calculation, as described above, if a non-operating day, a production stage replacement period, or the like is before the maintenance limit timings of the elements 1 to n, the maintenance timing calculation unit 103 may calculate a maintenance timing based on information about the non-operating day, the production stage replacement period, or the like. In the example in FIG. 17, maintenance operations are simultaneously performed on the elements 2 and 3 at a certain point T2 within the maintenance grace period [T2-1S, T2-1E] of the element 1, which is the maintenance target element. In addition, simply for ease of description, as in FIG. 12, the duration of each of the maintenance operations on the apparatuses is not illustrated in (A) to (C) of FIG. 17, and the maintenance operations bring the elements 1 to n to their respective normal states at the same timing (time). However, the elements 1 to n may. as a matter of course, require different time lengths to complete respective maintenance operations.

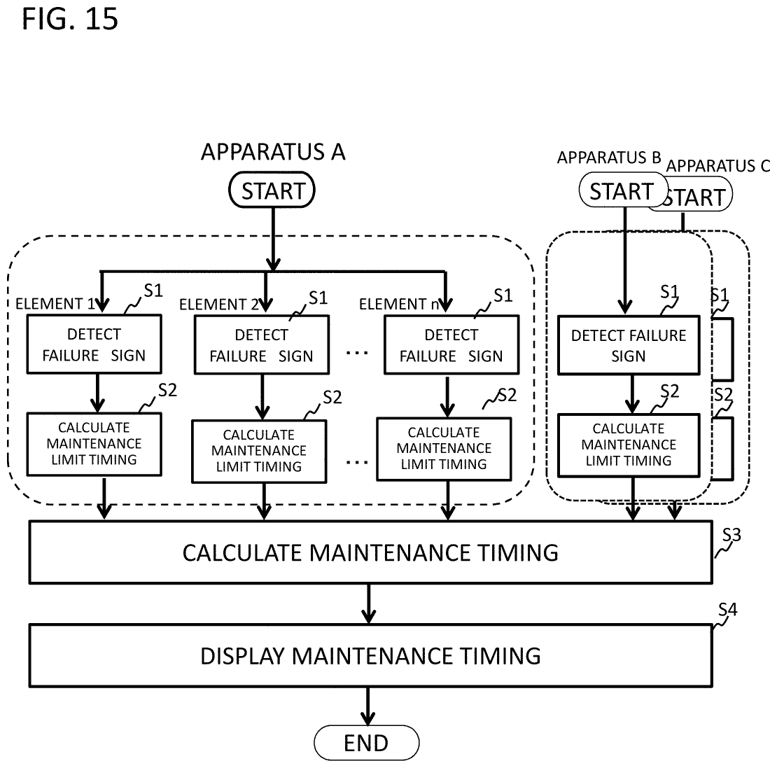

FIG. 15 illustrates a variation example 1 of the second example embodiment. In FIG. 15, failure sign detection processing is performed for each of the plurality of elements 1 to n in the apparatus A, while failure sign detection processing is performed for each of the apparatuses B and C (step S1). If an abnormality is detected in any of the elements 1 to n in the apparatus A, a maintenance limit timing is calculated for the corresponding element (step S2). In addition, a maintenance limit timing is calculated for each of the apparatuses B and C (step S2).

The maintenance timing calculation unit 103 calculates maintenance timings for the elements 1 to n of the apparatus A and for the apparatuses B and C, based on the maintenance limit timings calculated for the elements 1 to n in the apparatus A from which an abnormality has been detected, the maintenance limit timings calculated for the apparatuses B and C, and other information (a non-operating day, a production stage replacement period, etc.) (step S3).

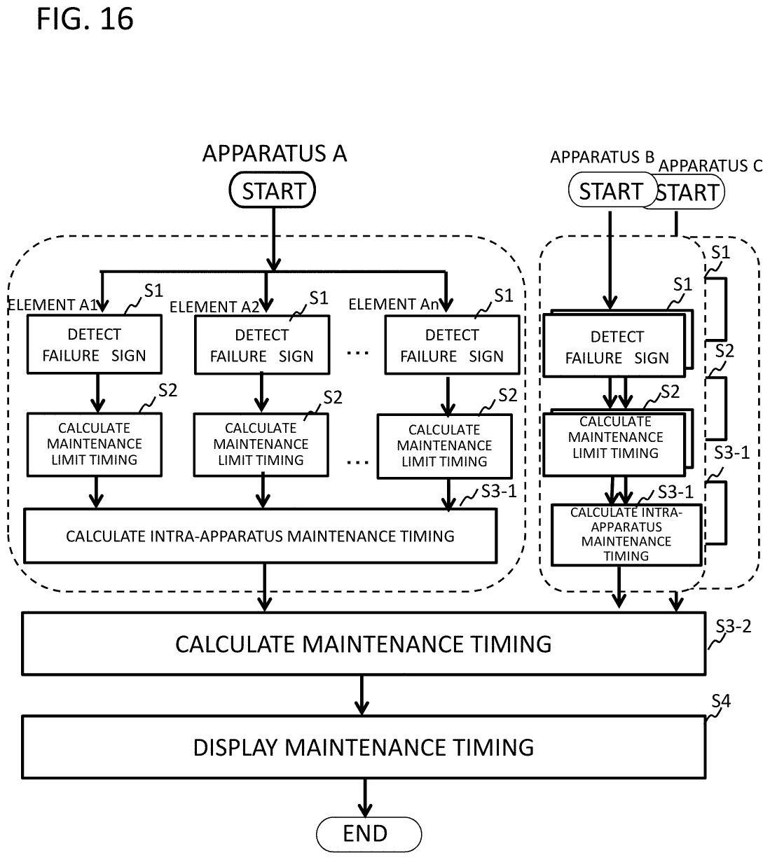

FIG. 16 illustrates a variation example 2 of the second example embodiment. In FIG. 16, failure sign detection processing is performed for each of a plurality of elements Al to An in the apparatus A, and failure sign detection processing is also performed for each of a plurality of elements in each of the apparatuses B and C (step S1). If an abnormality is detected in any of the elements in the apparatuses A to C, a maintenance limit timing is calculated for this element (step S2).

The maintenance timing calculation unit 103 calculates a maintenance timing for a plurality of elements in a single apparatus, based on the maintenance limit timings calculated for the elements in the apparatus, the maintenance limit timings calculated for the elements in the other apparatuses, and other information (a non-operating day, a production stage replacement period, etc.) (step S3-1).

Next, from the maintenance timings calculated for the respective apparatuses A to C, the maintenance timing calculation unit 103 calculates a common maintenance timing for the apparatuses A to C (step S3-2). In step S3-2, among the maintenance timings for the apparatuses, the maintenance timing calculation unit 103 can select the earliest maintenance timing at the time of the detection of the abnormalities from the apparatuses. By locally calculating a maintenance timing for an individual apparatus and calculating a common maintenance timing for a plurality of apparatus based on the maintenance timings for the respective apparatuses (a kind of divide and conquer algorithm), for example, even when the number of elements within an individual apparatus is large and abnormalities are detected in more elements in apparatus, the present invention can contribute to improvement in the efficiency of the arithmetic processing.

As in the first example embodiment, the above second example embodiment may also be implemented by the computer system 110 illustrated in FIG. 20. In the second example embodiment, too, regarding a maintenance operation(s) performed on an apparatus(es) based on a sign(s) of a failure(s) of a constituent element(s) of an apparatus(es), an appropriate maintenance plan can be formulated from a viewpoint of reduction in the stoppage time of a production line, etc.

While the first and second example embodiments have been described by using, as an example, maintenance operations performed on the apparatuses in a production line, the present invention is also applicable in the same way to electrical equipment at stores, etc. In this case, “production yield (reduction)” in FIG. 7A may be read as “sales (reduction)” at the store, for example. In addition, by reading “production plan” and “production result” in FIG. 5 as “sales target” and “sales result”, the configurations according to the first and second example embodiments can be applied.

The disclosure of each of the above PTLs 1 to 3 and NPLs 1 and 2 is incorporated herein by reference thereto. Variations and adjustments of the example embodiments and the examples are possible within the scope of the overall disclosure (including the claims) of the present invention and based on the basic technical concept of the present invention. Various combinations and selections of various disclosed elements (including the elements in the claims, examples, drawings, etc.) are possible within the scope of the claims of the present invention. That is, the present invention of course includes various variations and modifications that could be made by those skilled in the art according to the overall disclosure including the claims and the technical concept.

For example, the above example embodiments can be described, but not limited to, as the following Supplementary Notes.

### Supplementary Note 1

A maintenance plan formulation device comprising:

a failure sign detection unit that acquires a state of at least an apparatus and detects an abnormality indicating a sign that appears before a failure of the apparatus occurs;

a maintenance limit timing calculation unit that calculates a maintenance limit timing that indicates a limit of a maintenance timing of the apparatus in which the abnormality has been detected;

a maintenance timing calculation unit that calculates a maintenance timing of the apparatus based on the maintenance limit timing of the apparatus; and

a maintenance timing output unit that outputs the maintenance timing to a display apparatus.

### Supplementary Note 2

The maintenance plan formulation device according to supplementary note 1, wherein the maintenance limit timing calculation unit generates the maintenance grace period of the apparatus, an individual one of the maintenance grace periods starting when a corresponding abnormality is detected in the corresponding apparatus by the failure sign detection unit and ending at the corresponding maintenance limit timing, and

wherein the maintenance timing calculation unit sets the maintenance timing of the apparatus to a preset time within the corresponding maintenance grace period.

### Supplementary Note 3

The maintenance plan formulation device according to supplementary note 2, wherein, based on the maintenance grace period calculated for the apparatus and the maintenance grace period calculated for at least one other apparatus, the maintenance timing calculation unit calculates a maintenance timing common to the apparatus and the at least one other apparatus.

### Supplementary Note 4

The maintenance plan formulation device according to any one of supplementary notes 1 to 3, wherein the maintenance limit timing calculation unit calculates the maintenance limit timing based on a temporal transition after the abnormality of the state of the apparatus is detected and an acceptable value regarding the state of the apparatus.

### Supplementary Note 5

The maintenance plan formulation device according to any one of supplementary notes 1 to 4, comprising:

a storage apparatus that stores logged abnormality information related to an abnormality of the apparatus;

wherein, based on the logged abnormality information related to the abnormality of the apparatus, the maintenance limit timing calculation unit calculates an acceptable value regarding the state of the apparatus in association with an acceptable value about a yield of the product produced by the apparatus.

### Supplementary Note 6

The maintenance plan formulation device according to supplementary note 5, wherein the logged abnormality information includes a correlation between the yield of the product produced by the apparatus and a signal value representing the state of the apparatus,

wherein, based on at least one of a kind, a location, and a cause of the detected abnormality of an individual one of the apparatuses, the maintenance limit timing calculation unit selects logged abnormality information that corresponds to the at least one of the kind, the location, and the cause of the abnormality, and

wherein the maintenance limit timing calculation unit calculates an acceptable signal value corresponding to the acceptable value of a yield of the product produced by the apparatus with regard to the logged abnormality information selected and determines the acceptable signal value as the acceptable value regarding the state of the apparatus.

### Supplementary Note 7

The maintenance plan formulation device according to any one of supplementary notes 1 to 6, wherein the maintenance limit timing calculation unit calculates the maintenance limit timing based on a temporal transition after the abnormality of the state of the apparatus is detected, the temporal transition being predicted based on production plan information about the product produced by the apparatus in which the abnormality has been detected and actual production information on the product and the acceptable value regarding the state of the apparatus.

### Supplementary Note 8

The maintenance plan formulation device according to any one of supplementary notes 1 to 7, wherein the maintenance timing calculation unit calculates the maintenance timing of the apparatus based on, in addition to the maintenance limit timing of the apparatus, at least one of the maintenance limit timing of a other apparatus, a non-operating period, and a production stage replacement period.

### Supplementary Note 9

The maintenance plan formulation device according to any one of supplementary notes 1 to 7, wherein the maintenance timing calculation unit calculates the maintenance timing of the apparatus based on, in addition to the maintenance limit timing of the apparatus and a maintenance limit timing for a different abnormality detected in the apparatus, at least one of the maintenance limit timing of at least one other apparatus, a non-operating period, and a production stage replacement period.

### Supplementary Note 10

The maintenance plan formulation device according to any one of supplementary notes 1 to 9, wherein the failure sign detection unit detects the abnormality of the apparatus based on information acquired by at least one of a current sensor that acquires a power supply current of the apparatus, a vibration sensor that detects a vibration of the apparatus, and an image sensor that acquires image information about the apparatus.

### Supplementary Note 11

The maintenance plan formulation device according to any one of supplementary notes 1 to 10, wherein the failure sign detection unit acquires a power supply current waveform of the apparatus and detects an abnormality by comparing a feature amount of the power supply current waveform with a preset threshold.

### Supplementary Note 12

The maintenance plan formulation device according to supplementary note 11, wherein the failure sign detection unit acquires a power supply current waveform of the apparatus and detects an abnormality about the state of the apparatus by comparing a feature amount of the power supply current waveform with a preset threshold, and

wherein the maintenance limit timing calculation unit calculates the maintenance limit timing based on an acceptable value preset to the feature amount of the power supply current waveform of the apparatus in which the abnormality has been detected and a temporal transition after an abnormality about the feature amount of the power supply current waveform of the apparatus is detected.

### Supplementary Note 13

A maintenance plan formulation method performed by a computer, the method comprising:

a failure sign detection step for acquiring a state of at least an apparatus and detecting an abnormality indicating a sign that appears before a failure of the apparatus occurs;

a maintenance limit timing calculation step for calculating a maintenance limit timing that indicates a limit of a maintenance timing of the apparatus in which the abnormality has been detected;

a maintenance timing calculation step for calculating a maintenance timing of the apparatus based on the maintenance limit timing of the apparatus; and

a step for outputting the maintenance timing to a display apparatus.

### Supplementary Note 14

The maintenance plan formulation method according to supplementary note 13, wherein the maintenance limit timing calculation step generates the maintenance grace period of the apparatus, an individual one of the maintenance grace periods starting when a corresponding abnormality is detected in the corresponding apparatus and ending at the corresponding maintenance limit timing, and

wherein the maintenance timing calculation step sets the maintenance timing of the apparatus to a preset time within the maintenance grace period.

### Supplementary Note 15

The maintenance plan formulation method according to supplementary note 14, wherein, based on the maintenance grace period calculated for the apparatus and the maintenance grace period calculated for at least one other apparatus, the maintenance timing calculation step calculates a maintenance timing common to the apparatus and the at least one other apparatus.

### Supplementary Note 16

The maintenance plan formulation method according to any one of supplementary notes 13 to 15, wherein the maintenance limit timing calculation step calculates the maintenance limit timing based on a temporal transition after the abnormality of the state of the apparatus is detected and an acceptable value regarding the state of the apparatus.

### Supplementary Note 17

The maintenance plan formulation method according to any one of supplementary notes 13 to 16, wherein the maintenance limit timing calculation step refers to a storage apparatus that stores logged abnormality information related to an abnormality of the apparatus and calculates, based on the logged abnormality information related to the detected abnormality of the apparatus, an acceptable value regarding the state of the apparatus in association with an acceptable value about a yield of the product produced by the apparatus.

### Supplementary Note 18

The maintenance plan formulation method according to supplementary note 17, wherein the logged abnormality information includes a correlation between the yield of the product produced by the apparatus and a signal value representing deterioration of the state of the apparatus,

wherein, based on at least one of a kind, a location, and a cause of the detected abnormality of an individual one of the apparatuses, the maintenance limit timing calculation step selects logged abnormality information that corresponds to the at least one of the kind, the location, and the cause of the abnormality, and

wherein the maintenance limit timing calculation step calculates an acceptable signal value corresponding to the acceptable value of a yield of the product produced by the apparatus with regard to the logged abnormality information selected and determines the acceptable signal value as the acceptable value regarding the state of the apparatus.

### Supplementary Note 19

The maintenance plan formulation method according to any one of supplementary notes 13 to 18, wherein the maintenance limit timing calculation step calculates the maintenance limit timing based on a temporal transition after the abnormality of the state of the apparatus is detected, the temporal transition being predicted based on production plan information about the product produced by the apparatus in which the abnormality has been detected and actual production information on the product and the acceptable value regarding the state of the apparatus.

### Supplementary Note 20

The maintenance plan formulation method according to any one of supplementary notes 13 to 18, wherein the maintenance timing calculation step calculates the maintenance timing of the apparatus based on, in addition to the maintenance limit timing of the apparatus, at least one of the maintenance limit timing of at least one other apparatus, a non-operating period, and a production stage replacement period.

### Supplementary Note 21

The maintenance plan formulation method according to any one of supplementary notes 13 to 19, wherein the maintenance timing calculation step calculates the maintenance timing of the apparatus based on, in addition to the maintenance limit timing of the apparatus and a maintenance limit timing for a different abnormality detected in the apparatus, at least one of the maintenance limit timing of at least one other apparatus, a non-operating period, and a production stage replacement period.

### Supplementary Note 22

The maintenance plan formulation method according to any one of supplementary notes 13 to 21, wherein the failure sign detection step detects the abnormality of the apparatus based on information acquired by at least one of a current sensor that acquires a power supply current of the apparatus, a vibration sensor that detects a vibration of the apparatus, and an image sensor that acquires image information about the apparatus.

### Supplementary Note 23

The maintenance plan formulation method according to any one of supplementary notes 13 to 21, wherein the failure sign detection step acquires a power supply current waveform of the apparatus and detects an abnormality by comparing a feature amount of the power supply current waveform with a preset threshold.

### Supplementary Note 24

The maintenance plan formulation method according to supplementary note 23, wherein the failure sign detection step acquires a power supply current waveform of the apparatus and detects an abnormality about the state of the apparatus by comparing a feature amount of the power supply current waveform with a preset threshold, and

wherein the maintenance limit timing calculation step calculates the maintenance limit timing based on an acceptable value preset to the feature amount of the power supply current waveform of the apparatus in which the abnormality has been detected and a temporal transition after an abnormality about the feature amount of the power supply current waveform of the apparatus is detected.

### Supplementary Note 25

A non-transitory computer readable medium storing a program causing a computer to perform:

failure sign detection processing for acquiring a state of at least an apparatus and detecting an abnormality indicating a sign that appears before a failure of the apparatus occurs;

maintenance limit timing calculation processing for calculating a maintenance limit timing that indicates a limit of a maintenance timing of the apparatus in which the abnormality has been detected;

maintenance timing calculation processing for calculating a maintenance timing of the apparatus based on the maintenance limit timing of the apparatus; and

processing for outputting the maintenance timing to a display apparatus.

### Supplementary Note 26

The non-transitory computer readable medium according to supplementary note 25, wherein the maintenance limit timing calculation processing generates the maintenance grace period of the apparatus, an individual one of the maintenance grace periods starting when a corresponding abnormality is detected in the corresponding apparatus and ending at the corresponding maintenance limit timing, and

wherein the maintenance timing calculation processing sets the maintenance timing of the apparatus to a preset time within the maintenance grace period.

### Supplementary Note 27

The non-transitory computer readable medium according to supplementary note 26, wherein, based on the maintenance grace period calculated for the apparatus and the maintenance grace period calculated for at least one other apparatus, the maintenance timing calculation processing calculates a maintenance timing common to the apparatus and the at least one other apparatus.

### Supplementary Note 28

The non-transitory computer readable medium according to any one of supplementary notes 25 to 27, wherein the maintenance limit timing calculation unit calculates the maintenance limit timing based on a temporal transition after the abnormality of the state of the apparatus is detected and an acceptable value regarding the state of the apparatus.

### Supplementary Note 29

The non-transitory computer readable medium according to any one of supplementary notes 25 to 28, wherein the maintenance limit timing calculation processing refers to a storage apparatus that stores logged abnormality information related to an abnormality of the apparatus and calculates, based on the logged abnormality information related to the detected abnormality of the apparatus, an acceptable value regarding the state of the apparatus in association with an acceptable value about a yield of the product produced by the apparatus.

### Supplementary Note 30

The non-transitory computer readable medium according to supplementary note 29, wherein the logged abnormality information includes a correlation between the yield of the product produced by the apparatus and a signal value representing deterioration of the state of the apparatus;

wherein, based on at least one of a kind, a location, and a cause of the detected abnormality of an individual one of the apparatuses, the maintenance limit timing calculation processing selects logged abnormality information that corresponds to the at least one of the kind, the location, and the cause of the abnormality; and

wherein the maintenance limit timing calculation processing calculates an acceptable signal value corresponding to the acceptable value of a yield of the product produced by the apparatus with regard to the logged abnormality information selected and determines the acceptable signal value as the acceptable value regarding the state of the apparatus.

### Supplementary Note 31

The non-transitory computer readable medium according to any one of supplementary notes 25 to 30, wherein the maintenance limit timing calculation processing calculates the maintenance limit timing based on a temporal transition after the abnormality of the state of the apparatus is detected, the temporal transition being predicted based on production plan information about the product produced by the apparatus in which the abnormality has been detected and actual production information on the product and the acceptable value regarding the state of the apparatus.

### Supplementary Note 32

The non-transitory computer readable medium according to any one of supplementary notes 25 to 31, wherein the maintenance timing calculation processing calculates the maintenance timing of the apparatus based on, in addition to the maintenance limit timing of the apparatus, at least one of the maintenance limit timing of at least one other apparatus, a non-operating period, and a production stage replacement period.

### Supplementary Note 33

The non-transitory computer readable medium according to any one of supplementary notes 25 to 31, wherein the maintenance timing calculation processing calculates the maintenance timing of the apparatus based on, in addition to the maintenance limit timing of the apparatus and a maintenance limit timing for a different abnormality detected in the apparatus, at least one of the maintenance limit timing of at least one other apparatus, a non-operating period, and a production stage replacement period.

### Supplementary Note 34

The non-transitory computer readable medium according to any one of supplementary notes 25 to 33, wherein the failure sign detection processing detects the abnormality of the apparatus based on information acquired by at least one of a current sensor that acquires a power supply current of the apparatus, a vibration sensor that detects a vibration of the apparatus, and an image sensor that acquires image information about the apparatus.

### Supplementary Note 35

The non-transitory computer readable medium according to any one of supplementary notes 25 to 34, wherein the failure sign detection processing acquires a power supply current waveform of the apparatus and detects an abnormality by comparing a feature amount of the power supply current waveform with a preset threshold.

### Supplementary Note 36

The non-transitory computer readable medium according to any one of supplementary notes 35, wherein the failure sign detection processing acquires a power supply current waveform of the apparatus and detects an abnormality about the state of the apparatus by comparing a feature amount of the power supply current waveform with a preset threshold; and

wherein the maintenance limit timing calculation processing calculates the maintenance limit timing based on an acceptable value preset to the feature amount of the power supply current waveform of the apparatus in which the abnormality has been detected and a temporal transition after an abnormality about the feature amount of the power supply current waveform of the apparatus is detected.

What is claimed is:

1. A maintenance plan formulation device comprising:
a failure sign detection unit that acquires a state of at least a monitoring target apparatus and detects an abnormality indicating a sign that appears before a failure of the apparatus occurs;
a maintenance limit timing calculation unit that calculates a maintenance limit timing that indicates a limit of a maintenance timing of the apparatus with the abnormality thereof being detected;
a maintenance timing calculation unit that calculates a maintenance timing of the apparatus based on the maintenance limit timing of the apparatus; and
a maintenance timing output unit that outputs the maintenance timing to a display apparatus.

2. The maintenance plan formulation device according to claim 1, wherein the maintenance limit timing calculation unit generates a maintenance grace period of the apparatus, the maintenance grace period having a starting point set to a time when the abnormality of the apparatus is detected by the failure sign detection unit and an end point set to the maintenance limit timing, and
wherein the maintenance timing calculation unit sets the maintenance timing of the apparatus to a preset time within the maintenance grace period.

3. The maintenance plan formulation device according to claim 2, wherein, based on the maintenance grace period calculated for the apparatus and the maintenance grace period calculated for at least one other monitoring target apparatus, the maintenance timing calculation unit calculates a maintenance timing common to the apparatus and the at least one other monitoring target apparatus.

4. The maintenance plan formulation device according to claim 1, wherein the maintenance limit timing calculation unit calculates the maintenance limit timing based on a temporal transition after the abnormality of a state of the apparatus is detected and an acceptable value regarding the state of the apparatus.

5. The maintenance plan formulation device according to claim 1, comprising
a storage apparatus that stores logged abnormality information related to an abnormality of the apparatus,
wherein, based on the logged abnormality information related to the abnormality of the apparatus, the maintenance limit timing calculation unit calculates an acceptable value regarding the state of the apparatus in association with an acceptable value of a yield of a product produced by the apparatus.

6. The maintenance plan formulation device according to claim 5, wherein the logged abnormality information includes a correlation between the yield of the product produced by the apparatus and a signal value representing the state of the apparatus,
wherein, based on at least one of a kind, a location, and a cause of the detected abnormality of the apparatus, the maintenance limit timing calculation unit selects logged abnormality information that corresponds to the at least one of a kind, a location, and a cause of the abnormality, and
the maintenance limit timing calculation unit calculates an acceptable signal value corresponding to the acceptable value of a yield of the product produced by the apparatus with regard to the logged abnormality information selected and determines the acceptable signal value as the acceptable value regarding the state of the apparatus.

7. The maintenance plan formulation device according to claim 1, wherein the maintenance limit timing calculation unit determines the maintenance limit timing based on a temporal transition after detection of the abnormality of the state of the apparatus, the temporal transition being predicted based on production plan information about the product, production of which the apparatus with the abnormality thereof being detected is involved in and actual production information on the product, and the acceptable value regarding the state of the apparatus.

8. The maintenance plan formulation device according to claim 1, wherein the maintenance timing calculation unit calculates the maintenance timing of the apparatus based on, in addition to the maintenance limit timing of the apparatus, at least one of the maintenance limit timing of at least one other monitoring target apparatus, a non-operating period, and a production stage replacement period.

9. The maintenance plan formulation device according to claim 1, wherein the maintenance timing calculation unit calculates the maintenance timing of the apparatus based on, in addition to the maintenance limit timing of the apparatus and a maintenance limit timing for a different abnormality detected in the apparatus, at least one of the maintenance limit timing of at least one other monitoring target apparatus, a non-operating period, and a production stage replacement period.

10. The maintenance plan formulation device according to claim 1, wherein the failure sign detection unit detects the abnormality of the apparatus based on information acquired by at least one sensor which is one of a current sensor that acquires a power supply current of the apparatus, a vibration sensor that detects a vibration of the apparatus, and an image sensor that acquires image information about the apparatus.

11. The maintenance plan formulation device according to claim 1, wherein the failure sign detection unit acquires a power supply current waveform of the apparatus to detect an abnormality by comparing a feature amount of the power supply current waveform with a preset threshold.

12. The maintenance plan formulation device according to claim 1, wherein the failure sign detection unit acquires a power supply current waveform of the apparatus and detects an abnormality of the state of the apparatus by comparing a feature amount of the power supply current waveform with a preset threshold, and
wherein the maintenance limit timing calculation unit calculates the maintenance limit timing based on an acceptable value preset to the feature amount of the power supply current waveform of the apparatus with the abnormality thereof being detected and a temporal transition after an abnormality about the feature amount of the power supply current waveform of the apparatus is detected.

13. A maintenance plan formulation method performed by a computer, the method comprising:
acquiring a state of at least a monitoring target apparatus and detecting an abnormality indicating a sign that appears before a failure of the apparatus occurs;
calculating a maintenance limit timing that indicates a limit of a maintenance timing of the apparatus with the abnormality thereof being detected;
calculating a maintenance timing of the apparatus based on the maintenance limit timing of the apparatus; and
outputting the maintenance timing to a display apparatus.

14. A non-transitory computer readable medium storing a program causing a computer to perform processing, the processing comprising:
acquiring a state of at least a monitoring target apparatus and detecting an abnormality indicating a sign that appears before a failure of the apparatus occurs;
calculating a maintenance limit timing that indicates a limit of a maintenance timing of the apparatus with the abnormality thereof being detected;
calculating a maintenance timing of the apparatus based on the maintenance limit timing of the apparatus; and
outputting the maintenance timing to a display apparatus.
